(19) United States
(12) Patent Application Publication
(10) Pub. No.: US 2008/0291830 A1
(43) Pub. Date: Nov. 27, 2008

(54) MULTIRADIO CONTROL INCORPORATING QUALITY OF SERVICE

(75) Inventors: Ville Pernu, Tampere (FI); Jussi Ylanen, Lempaala (FI); Jani Okker, Tampere (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/753,867

(22) Filed: May 25, 2007

(51) Int. Cl. G06F 11/00; H04J 3/14

(52) U.S. Cl. 370/236

(57) ABSTRACT

A system for managing the operation of one or more of wireless communication mediums supported by one or more radio modules integrated within a WCD. A control strategy may be employed to evaluate and manage pending communication activity down to the wireless message stream level through the creation of operational schedules. The operational schedules may be utilized by the one or more radio modules in the WCD in order to determine how resource usage should be allocated for supporting the communication activities conducted over a radio module.

### BACKGROUND OF INVENTION

1. Field of Invention

The present invention relates to a system for managing one or more radio modules integrated within a wireless communication device, and more specifically, to a multiradio control system enabled to schedule wireless communication to the message level by considering various criteria when creating operational schedules, such as priority and required quality of service.

2. Description of Prior Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices (WCDs) have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate WCD communication over large geographic areas. These network technologies have commonly been divided by generations, starting in the late 1970s to early 1980s with first generation (1G) analog cellular telephones that provided baseline voice communication, to modem digital cellular telephones. GSM is an example of a widely employed 2G digital cellular network communicating in the 900 MHz/1.8 GHz bands in Europe and at 850 MHz and 1.9 GHz in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A 1 Mbps Bluetooth™ radio may transmit and receive data at a rate of 720 Kbps within a range of 10 meters, and may transmit up to 100 meters with additional power boosting. Enhanced data rate (EDR) technology also available may enable maximum asymmetric data rates of 1448 Kbps for a 2 Mbps connection and 2178 Kbps for a 3 Mbps connection. A user does not actively instigate a Bluetooth™ network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth™ other popular short-range wireless networks include WLAN (of which “Wi-Fi” local access points communicating in accordance with the IEEE 802.11 standard, is an example), WUSB, UWB, ZigBee (802.15.4, 802.15.4a), and UHF RFID. All of these wireless mediums have features and advantages that make them appropriate for various applications.

More recently, manufacturers have also begun to incorporate various resources for providing enhanced functionality in WCDs (e.g., components and software for performing close-proximity wireless information exchanges). Sensors and/or scanners may be used to read visual or electronic information into a device. A transaction may involve a user holding their WCD in proximity to a target, aiming their WCD at an object (e.g., to take a picture) or sweeping the device over a printed tag or document. Near Field communication (NFC) technologies include machine-readable mediums such as radio frequency identification (RFID), Infra-red (IR) communication, optical character recognition (OCR) and various other types of visual, electronic and magnetic scanning are used to quickly input desired information into the WCD without the need for manual entry by a user.

Device manufacturers continue to incorporate as many of the previously discussed exemplary communication features as possible into wireless communication devices in an attempt to bring powerful, “do-all” devices to market. Devices incorporating long-range, short-range and NFC resources often include multiple mediums for each category. This may allow a WCD to flexibly adjust to its surroundings, for example, communicating both with a WLAN access point and a Bluetooth™ communication accessory, possibly at the same time.

Given the large array communication features that may be compiled into a single device, it is foreseeable that a user will need to employ a WCD to its full potential when replacing other productivity related devices. For example, a user may utilize a fully-functioned WCD to replace traditional tools such as individual phones, facsimile machines, computers, storage media, etc. which tend to be cumbersome to both integrate and transport. In at least one use scenario, a WCD may be communicating simultaneously over numerous different wireless mediums. A user may utilize multiple peripheral Bluetooth™ devices (e.g., a headset and a keyboard) while having a voice conversation over GSM and interacting with a WLAN access point in order to access the Internet. Problems may occur when these concurrent transactions cause interference with each other. Even if a communication medium does not have an identical operating frequency as another medium, a radio modem may cause extraneous interference to another medium. Further, it is possible for the combined effects of two or more simultaneously operating radios to create intermodulation effects to another bandwidth due to harmonic effects. These disturbances may cause errors resulting in the required retransmission of lost packets, and the overall degradation of performance for one or more communication mediums.

Emerging communication management strategies may, in some instances, be able to evaluate the pending communications (e.g., queued packet traffic) for a particular wireless communication medium or radio module in a wireless device in order to adjust the operation of the various active radio modules to avoid any potential conflict situations. The decisions made in avoiding communication problems may be made, for example, on the basis of a priority of a particular wireless communication medium or supporting radio module. While this strategy may serve as a rudimentary basis for managing relatively simultaneous communication in a WCD, communication resources may still be wasted, may result in a detrimental impact in overall communication performance for the WCD, due to the lack of narrow control resolution.

More specifically, each active wireless communication medium in the one or more wireless communication mediums that may be supported by one or more radio modules integrated within a WCD may include multiple message streams. These message streams may, for example, be created or used by different applications on the device, and therefore, may exhibit different characteristics. For example, certain applications may require high bandwidth, such as in the case of a streaming an audio and/or video broadcast. The receipt of such wireless signals may consume a large amount of the available resources in a WCD. Further, some message streams may have a greater importance than other activities also occurring in a WCD. For instance, a telephone call may not have as high a bandwidth requirement as the previously discussed audio and/or video applications, however, it may be deemed to have a higher importance to a user. These message streams may, in some cases, be conducted through the same wireless communication medium (e.g., Bluetooth™), and therefore, the management of resources at the radio module or wireless communication medium level may not possess the required finite control resolution needed to optimize overall communication activity in a WCD.

What is therefore needed is a system for managing wireless resources in the same wireless communication device, wherein the control entity is enabled to manage communication resources for individual wireless message streams, even if they are conducted over the same wireless communication medium. The system should be able to obtain information regarding these wireless message streams, the information being utilized to prioritize the wireless message streams before allocating timeslots to them in an operational schedule. The information may further contain quality level information, or quality of service, required by a particular wireless message stream. The management system should further be enabled to evaluate the operational schedule in view of this required quality of service, and if the quality of service cannot met (e.g., due to resource usage by a higher priority wireless message stream), the control entity should be enabled to make a judgment as to whether the wireless message stream should be canceled, making resources available for wireless message streams with an achievable quality level.

### SUMMARY OF INVENTION

The present invention includes at least a method, device, computer program and radio module configurable for use in a system for managing the operation of one or more of wireless communication mediums supported by one or more radio modules integrated within a WCD. In at least one embodiment of the present invention, a control strategy may be employed to evaluate and manage pending communication activity down to the wireless message stream level through the creation of operational schedules. The operational schedules may be utilized by the one or more radio modules in the WCD in order to determine how resource usage should be allocated for supporting the various communication activities conducted over a radio module.

In at least one exemplary implementation, a multiradio controller also integrated within the WCD may receive information from the one or more radio modules alone or in combination with information provided by other software (e.g., the master control system) and/or hardware resources of the WCD. The multiradio controller may then use this received information to compute operational schedules for distribution to the one or more radio modules.

The information received by the multiradio controller pertaining to each wireless message stream may include, for example, a particular wireless communication medium and/or radio module desired for use by a wireless message stream, priority information for a wireless message stream, a required Quality of Service (QoS) level for a wireless message stream, etc. This information may be used to determine an relative priority for each wireless message stream, which may be used when determining how to allocate resources in each operational schedule.

### DESCRIPTION OF DRAWINGS

The invention will be further understood from the following detailed description of a preferred embodiment, taken in conjunction with appended drawings, in which:

FIG. 1 discloses an exemplary wireless operational environment, including wireless communication mediums of different effective range.

FIG. 2 discloses a modular description of an exemplary wireless communication device usable with at least one embodiment of the present invention.

FIG. 3 discloses an exemplary structural description of the wireless communication device previously described in FIG. 2.

FIG. 4A discloses an exemplary operational description of a wireless communication device utilizing a wireless communication medium in accordance with at least one embodiment of the present invention.

FIG. 4B discloses an operational example wherein interference occurs when utilizing multiple radio modems simultaneously within the same wireless communication device.

FIG. 5A discloses an example of single mode radio modules usable with at least one embodiment of the present invention.

FIG. 5B discloses an example of a multimode radio module usable with at least one embodiment of the present invention.

FIG. 6A discloses an exemplary structural description of a wireless communication device including a multiradio controller in accordance with at least one embodiment of the present invention.

FIG. 6B discloses a more detailed structural diagram of FIG. 6A including the multiradio controller and the radio modems.

FIG. 6C discloses an exemplary operational description of a wireless communication device including a multiradio controller in accordance with at least one embodiment of the present invention.

FIG. 7A discloses an exemplary structural description of a wireless communication device including a multiradio control system in accordance with at least one embodiment of the present invention.

FIG. 7B discloses a more detailed structural diagram of FIG. 7A including the multiradio control system and the radio modems.

FIG. 7C discloses an exemplary operational description of a wireless communication device including a multiradio control system in accordance with at least one embodiment of the present invention.

FIG. 8A discloses an exemplary structural description of a wireless communication device including a distributed multiradio control system in accordance with at least one embodiment of the present invention.

FIG. 8B discloses a more detailed structural diagram of FIG. 8A including the distributed multiradio control system and the radio modems.

FIG. 8C discloses an exemplary operational description of a wireless communication device including a distributed multiradio control system in accordance with at least one embodiment of the present invention.

FIG. 9A discloses an exemplary structural description of a wireless communication device including a distributed multiradio control system in accordance with an alternative embodiment of the present invention.

FIG. 9B discloses a more detailed structural diagram of FIG. 9A including the distributed multiradio control system and the radio modems.

FIG. 9C discloses an exemplary operational description of a wireless communication device including a distributed multiradio control system in accordance with the alternative embodiment of the present invention disclosed in FIG. 9A.

FIG. 10 discloses an exemplary information packet usable with at least one embodiment of the present invention.

FIG. 11A discloses an example of resolving communication resource control down to the wireless message stream level in accordance with at least one embodiment of the present invention.

FIG. 11B discloses an example of information relevant to communication that may be exchanged between three components of a wireless communication device in accordance with at least one embodiment of the present invention.

FIG. 11C discloses an example of information relevant to communication that may be exchanged between two components of a wireless communication device in accordance with at least one embodiment of the present invention.

FIG. 12A discloses an exemplary problem scenario and the effect of applying the present invention, in accordance with at least one embodiment, in order to resolve the problem scenario.

FIG. 12B discloses another exemplary problem scenario and the effect of applying the present invention, in accordance with at least one embodiment, in order to resolve the problem scenario.

FIG. 13 discloses an exemplary flowchart for a process for managing communication resources in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Over Different Communication Networks

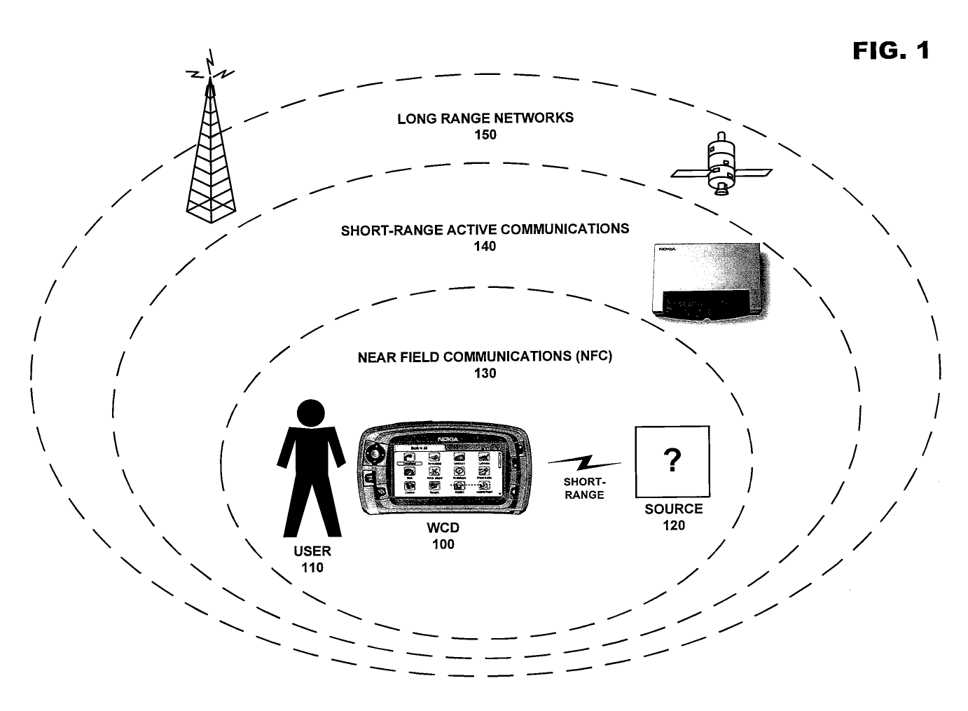

A WCD may both transmit and receive information over a wide array of wireless communication networks, each with different advantages regarding speed, range, quality (error correction), security (encoding), etc. These characteristics will dictate the amount of information that may be transferred to a receiving device, and the duration of the information transfer. FIG. 1 includes a diagram of a WCD and how it interacts with various types of wireless networks.

In the example pictured in FIG. 1, user 110 possesses WCD 100. This device may be anything from a basic cellular handset to a more complex device such as a wirelessly enabled palmtop or laptop computer. Near Field Communication (NFC) 130, in accordance with at least one embodiment of the present invention, may include various transponder-type interactions wherein normally only the scanning device requires its own power source. WCD 100 scans source 120 via short-range communication. A transponder in source 120 may use the energy and/or clock signal contained within the scanning signal, as in the case of RFID communication, to respond with data stored in the transponder. These types of technologies usually have an effective transmission range on the order of ten feet, and may be able to deliver stored data in amounts from a bit to over a megabit (or 125 Kbytes) relatively quickly. These features make such technologies well suited for identification purposes, such as to receive an account number for a public transportation provider, a key code for an automatic electronic door lock, an account number for a credit or debit transaction, etc.

The transmission range between two devices may be extended if both devices are capable of performing powered communication. Short-range active communication 140 includes applications wherein the sending and receiving devices are both active. An exemplary situation would include user 110 coming within effective transmission range of a Bluetooth™, WLAN, UWB, WUSB, etc. access point. In the case of Bluetooth™, a network may automatically be established to transmit information to WCD 100 possessed by user 110. This data may include information of an informative, educational or entertaining nature. The amount of information to be conveyed is unlimited, except that it must all be transferred in the time when user 110 is within effective transmission range of the access point. Due to the higher complexity of these wireless networks, additional time is also required to establish the initial connection to WCD 100, which may be increased if many devices are queued for service in the area proximate to the access point. The effective transmission range of these networks depends on the technology, and may be from some 30 ft. to over 300 ft. with additional power boosting.

Long-range networks 150 are used to provide virtually uninterrupted communication coverage for WCD 100. Land-based radio stations or satellites are used to relay various communication transactions worldwide. While these systems are extremely functional, the use of these systems is often charged on a per-minute basis to user 110, not including additional charges for data transfer (e.g., wireless Internet access). Further, the regulations covering these systems may cause additional overhead for both the users and providers, making the use of these systems more cumbersome.

### II. Wireless Communication Device

As previously described, the present invention may be implemented using a variety of wireless communication equipment. Therefore, it is important to understand the communication tools available to user 110 before exploring the present invention. For example, in the case of a cellular telephone or other handheld wireless devices, the integrated data handling capabilities of the device play an important role in facilitating transactions between the transmitting and receiving devices.

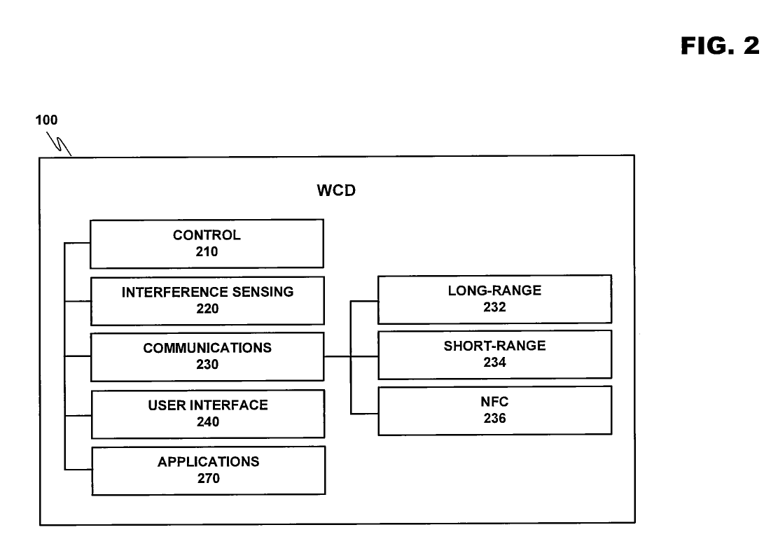

FIG. 2 discloses an exemplary modular layout for a wireless communication device usable with the present invention. WCD 100 is broken down into modules representing the functional aspects of the device. These functions may be performed by the various combinations of software and/or hardware components discussed below.

Control module 210 regulates the operation of the device. Inputs may be received from various other modules included within WCD 100. For example, interference sensing module 220 may use various techniques known in the art to sense sources of environmental interference within the effective transmission range of the wireless communication device. Control module 210 interprets these data inputs, and in response, may issue control commands to the other modules in WCD 100.

Communications module 230 incorporates all of the communication aspects of WCD 100. As shown in FIG. 2, communications module 230 may include, for example, long-range communications module 232, short-range communications module 234 and NFC module 236. Communications module 230 may utilize one or more of these sub-modules to receive a multitude of different types of communication from both local and long distance sources, and to transmit data to recipient devices within the transmission range of WCD 100. Communications module 230 may be triggered by control module 210, or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

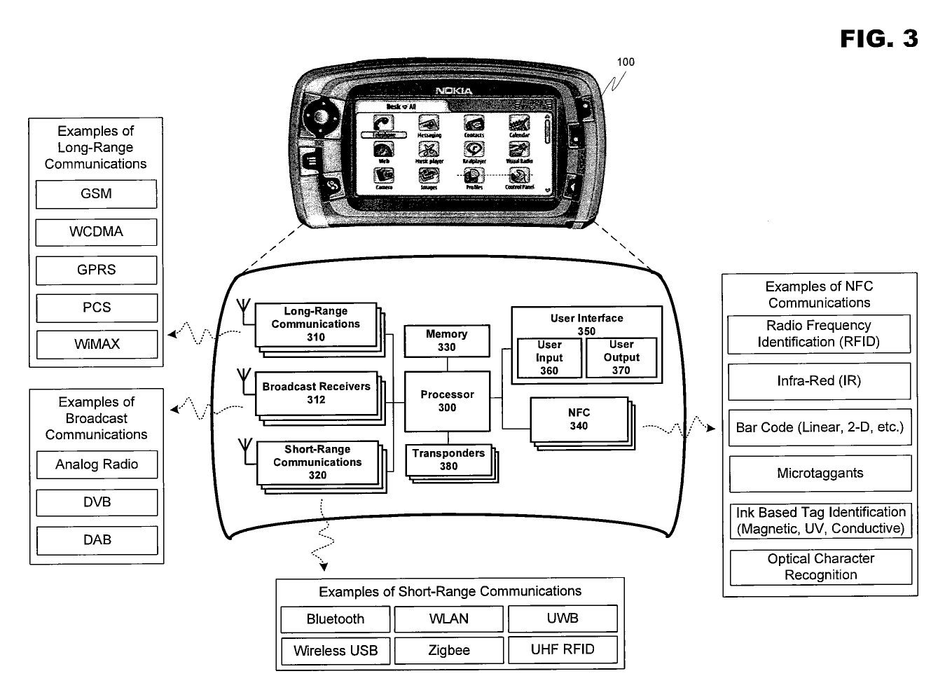

FIG. 3 discloses an exemplary structural layout of WCD 100 according to an embodiment of the present invention that may be used to implement the functionality of the modular system previously described in FIG. 2. Processor 300 controls overall device operation. As shown in FIG. 3, processor 300 is coupled to one or more communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communication utilities modules required to support WCD 100.

Long-range communications 310 performs functions related to the exchange of information over large geographic areas (such as cellular networks) via an antenna. These communication methods include technologies from the previously described 1G to 3G. In addition to basic voice communication (e.g., via GSM), long-range communications 310 may operate to establish data communication sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages.

As a subset of long-range communications 310, or alternatively operating as an independent module separately connected to processor 300, transmission receiver 312 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 320 is responsible for functions involving the exchange of information across short-range wireless networks. As described above and depicted in FIG. 3, examples of such short-range communications 320 are not limited to Bluetooth™, WLAN, UWB and Wireless USB connections. Accordingly, short-range communications 320 performs functions related to the establishment of short-range connections, as well as processing related to the transmission and reception of information via such connections.

NFC 340, also depicted in FIG. 3, may provide functionality related to the short-range scanning of machine-readable data. For example, processor 300 may control components in NFC 340 to generate RF signals for activating an RFID transponder, and may in turn control the reception of signals from an RFID transponder. Other short-range scanning methods for reading machine-readable data that may be supported by the NFC 340 are not limited to IR communication, linear and 2-D (e.g., QR) bar code readers (including processes related to interpreting UPC labels), and optical character recognition devices for reading magnetic, UV, conductive or other types of coded data that may be provided in a tag using suitable ink. In order for the NFC 340 to scan the aforementioned types of machine-readable data, the input device may include optical detectors, magnetic detectors, CCDs or other sensors known in the art for interpreting machine-readable information.

As further shown in FIG. 3, user interface 350 is also coupled to processor 300. User interface 350 facilitates the exchange of information with a user. FIG. 3 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, an RFID scanner mounted in an entryway may continuously emit radio frequency waves. When a person with a device containing transponder 380 walks through the door, the transponder is energized and may respond with information identifying the device, the person, etc. In addition, a scanner may be mounted (e.g., as previously discussed above with regard to examples of NFC 340) in WCD 100 so that it can read information from other transponders in the vicinity.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communication components stored in memory 330.

The elements shown in FIG. 3 may be constituted and coupled according to various techniques in order to produce the functionality described in FIG. 2. One such technique involves coupling separate hardware components corresponding to processor 300, communications sections 310, 312 and 320, memory 330, NFC 340, user interface 350, transponder 380, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communication utilities software component, also contained in memory 330, which provides for the establishment of service sessions using long-range communications 310 and/or short-range communications 320. The communication utilities component may include various routines that allow the reception of services from remote devices according to mediums such as the Wireless Application Medium (WAP), Hypertext Markup Language (HTML) variants like Compact HTML (CHTML), etc.

### III. Exemplary Operation of a Wireless Communication Device Including Potential Interference Problems Encountered.

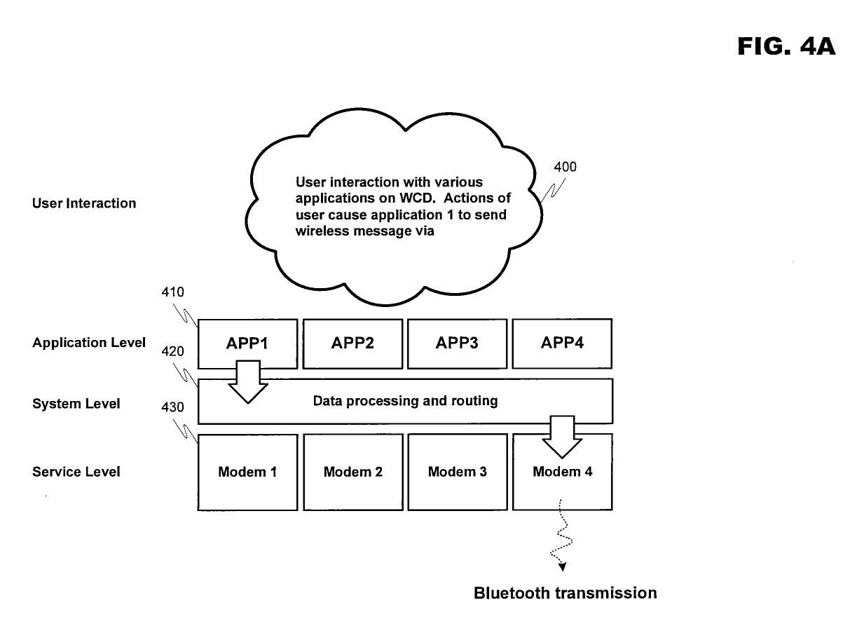

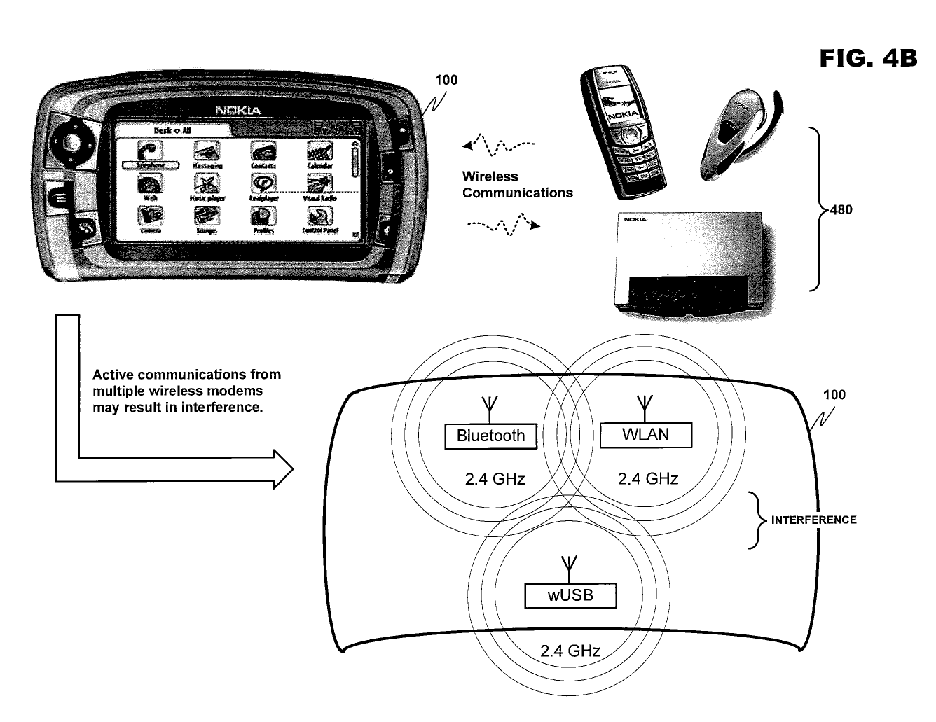

FIG. 4A discloses a stack approach to understanding the operation of a WCD in accordance with at least one embodiment of the present invention. At the top level 400, user 110 interacts with WCD 100. The interaction involves user 110 entering information via user input 360 and receiving information from user output 370 in order to activate functionality in application level 410. In the application level, programs related to specific functionality within the device interact with both the user and the system level. These programs include applications for visual information (e.g., web browser, DVB-H receiver, etc.), audio information (e.g., cellular telephone, voice mail, conferencing software, DAB or analog radio receiver, etc.), recording information (e.g., digital photography software, word processing, scheduling, etc.) or other information processing. Actions initiated at application level 410 may require information to be sent from or received into WCD 100. In the example of FIG. 4A, data is requested to be sent to a recipient device via Bluetooth™ communication. As a result, application level 410 may then call resources in the system level to initiate the required processing and routing of data.

System level 420 processes data requests and routes the data for transmission. Processing may include, for example, calculation, translation, conversion and/or packetizing the data. The information may then be routed to an appropriate communication resource in the service level. If the desired communication resource is active and available in the service level 430, the packets may be routed to a radio modem for delivery via wireless transmission. There may be a plurality of modems operating using different wireless mediums. For example, in FIG. 4A, modem 4 is activated and able to send packets using Bluetooth™ communication. However, a radio modem (as a hardware resource) need not be dedicated only to a specific wireless medium, and may be used for different types of communication depending on the requirements of the wireless medium and the hardware characteristics of the radio modem.

FIG. 4B discloses a situation wherein the above described exemplary operational process may cause more than one radio modem to become active. In this case, WCD 100 is both transmitting and receiving information via wireless communication over a multitude of mediums. WCD 100 may be interacting with various secondary devices such as those grouped at 480. For example, these devices may include cellular handsets communicating via long-range wireless communication like GSM, wireless headsets communicating via Bluetooth™, Internet access points communicating via WLAN, etc.

Problems may occur when some or all of these communications are carried on simultaneously. As further shown in FIG. 4B, multiple modems operating simultaneously may cause interference for each other. Such a situation may be encountered when WCD 100 is communicating with more than one external device (as previously described). In an exemplary extreme case, devices with modems simultaneously communicating via Bluetooth™, WLAN and wireless USB would encounter substantial overlap since all of these wireless mediums operate in the 2.4 GHz band. The interference, shown as an overlapping portion of the fields depicted in FIG. 4B, would cause packets to be lost and the need for retransmission of these lost packets. Retransmission requires that future time slots be used to retransmit lost information, and therefore, overall communication performance will at least be reduced, if the signal is not lost completely. The present invention, in at least one embodiment, seeks to manage problematic situations where possibly conflicting communications may be occurring simultaneously so that interference is minimized or totally avoided, and as a result, speed and quality are maximized.

### IV. Radio Modem Signal Control in a Wireless Communication Device.

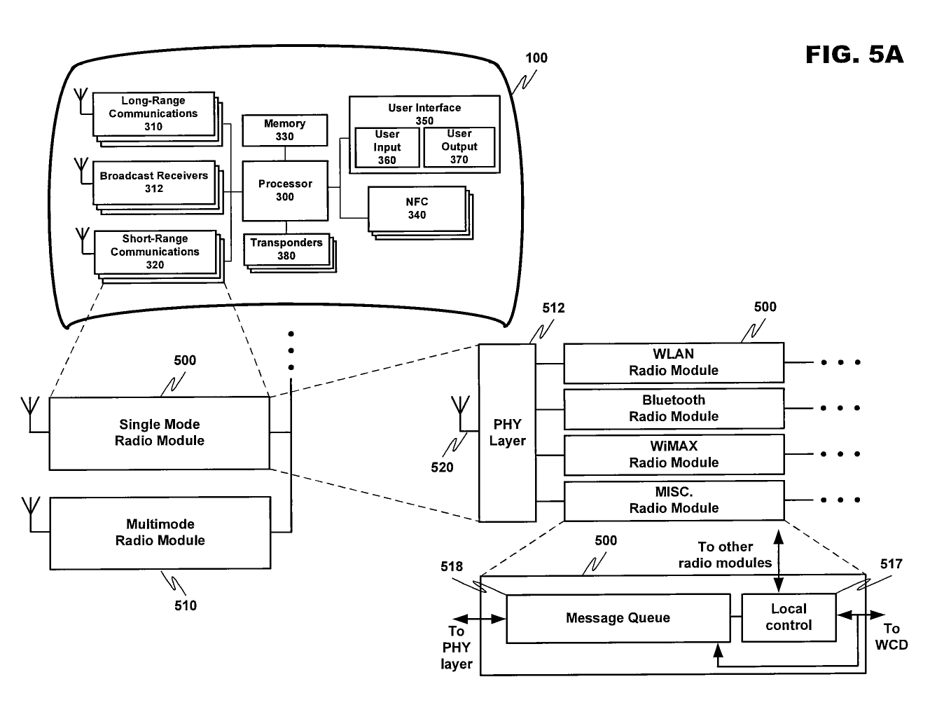

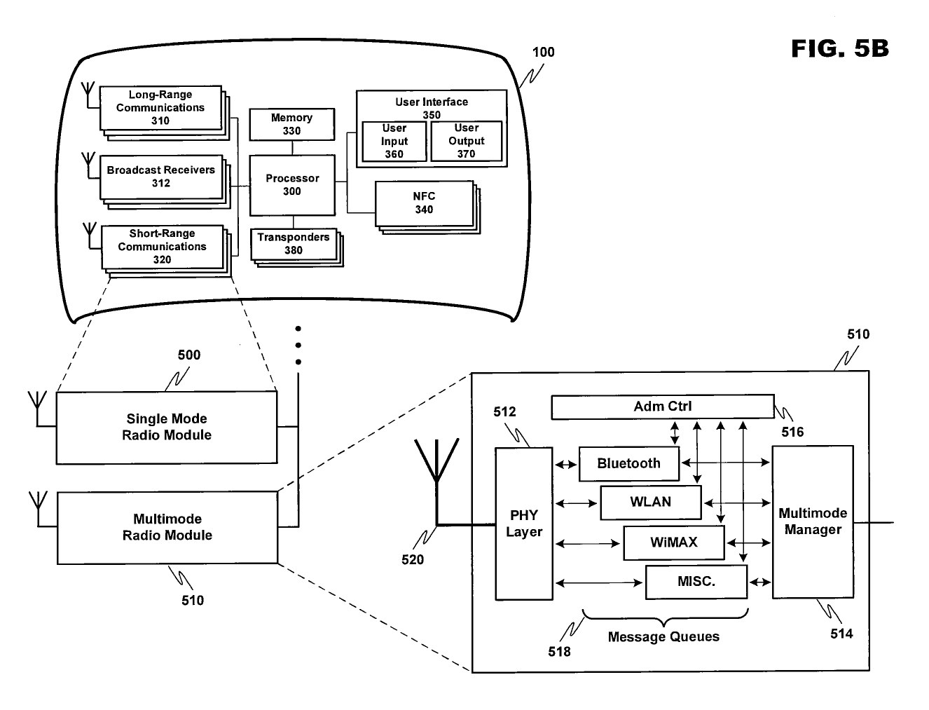

FIG. 5A discloses an example of different types of radio modules that may be implemented in WCD 100. The choice of radio modules to utilize may depend on various requirements for functionality in WCD 100, or conversely, on limitations in the device such as space or power limitations. Radio module 500 is a single mode radio module and radio module 510 is a multimode radio module (explained further in FIG. 5B). Single mode radio module 500 may only support one wireless communication medium at a time (e.g., a single mode radio module may be configured to support Bluetooth™) and may share physical resources (e.g. physical layer 512) such as a common antenna 520 or an antenna array and associated hardware.

Since all of the single mode radio modules may share the resource of physical layer 512 as depicted in FIG. 5A, some sort of control must exist in order to control how each single mode radio module 500 uses these resources. Local controller 517 may therefore be included in each radio modem to control the usage of PHY layer 512. This local controller may take as inputs message information from other components within WCD 100 wishing to send messages via single mode radio module 500 and also information from other single mode radio modules 500 as to their current state. This current state information may include a priority level, an active/inactive state, a number of messages pending, a duration of active communication, etc. Local controller 517 may use this information to control the release of messages from message queue 518 to PHY layer 512, or further, to control the quality level of the messages sent from message queue 518 in order to conserve resources for other wireless communication mediums. The local control in each single mode radio module 500 may take the form of, for example, a schedule for utilization of a wireless communication medium implemented in the radio module.

An exemplary multimode radio module 510 is now explained in FIG. 5B. Multimode radio module 510 may include local control resources for managing each “radio” (e.g., software based radio control stacks) attempting to use the physical layer (PHY) resources of multimode radio module 510. In this example, multimode radio module 510 includes at least three radio stacks or radio protocols (labeled Bluetooth, WLAN and WiMAX in FIG. 5B) that may share the PHY layer resources (e.g., hardware resources, antenna, etc.) of multimode radio module 510. The local control resources may include an admission controller (Adm Ctrl 516) and a multimode controller (Multimode Manager 514). These local control resources may be embodied as a software program and/or in a hardware form (e.g., logic device, gate array, MCM, ASIC, etc.) in a radio modem interface, and the radio modem interface may be coupled to, or alternatively, embedded in multimode radio module 510.

Admission control 516 may act as a gateway for the multimode radio module 510 by filtering out both different wireless communication medium requests from the operating system of WCD 100 that may be sent by multimode radio module 510 and that may further result in conflicts for multimode radio module 510. The conflict information may be sent along with operational schedule information for other radio modules to multimode manager 514 for further processing. The information received by multimode manager 514 may then be used to formulate a schedule, such as a schedule for utilization of wireless communication mediums, controlling the release of messages for transmission from the various message queues 518.

### V. A Wireless Communication Device Including a Multiradio Controller.

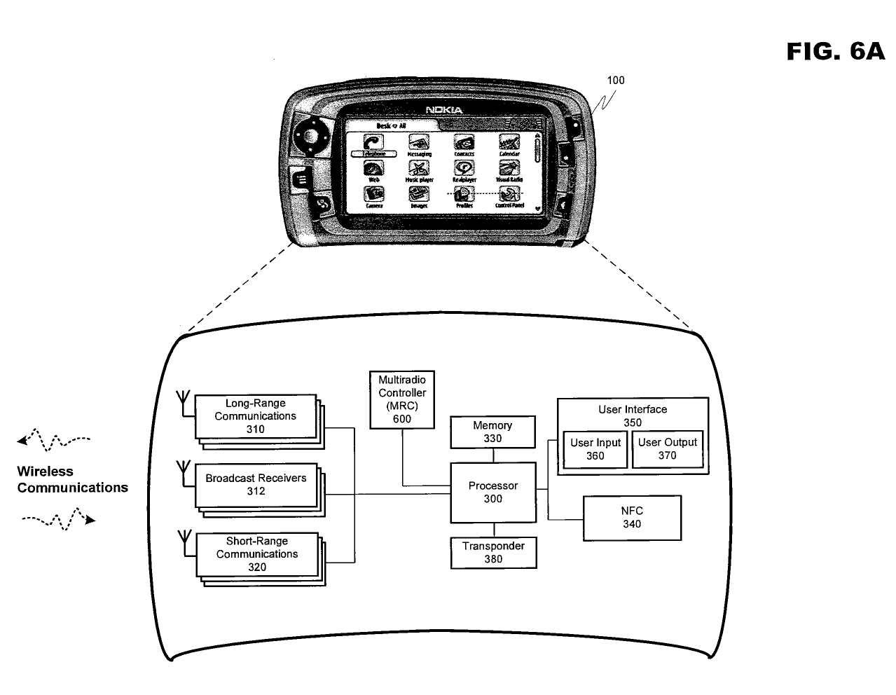

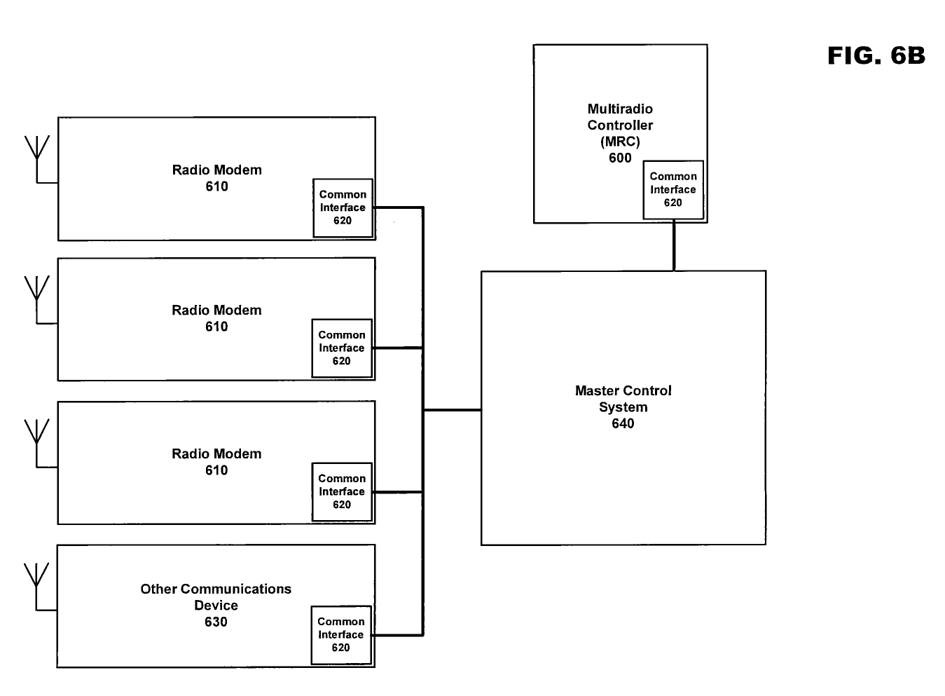

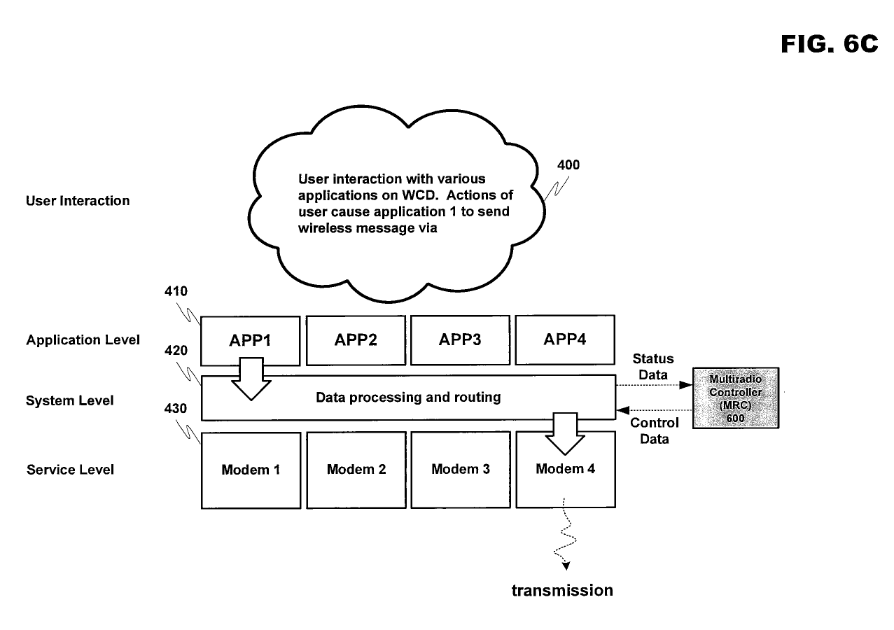

In an attempt to better manage communication in WCD 100, an additional controller dedicated to managing wireless communication may be introduced. WCD 100, as pictured in FIG. 6A, includes a multiradio controller (MRC) 600 in accordance with at least one embodiment of the present invention. MRC 600 is coupled to the master control system of WCD 100. This coupling enables MRC 600 to communicate with radio modems or other similar devices in communications modules 310 312, 320 and 340 via the master operating system of WCD 100.

FIG. 6B discloses in detail at least one embodiment of WCD 100, which may include multiradio controller (MRC) 600 introduced in FIG. 6A in accordance with at least one embodiment of the present invention. MRC 600 includes common interface 620 by which information may be sent or received through master control system 640. Radio modems 610 and other devices 630 may also be referred to as “modules” in this disclosure as they may contain supporting hardware and/or software resources in addition to the modem itself. These resources may include control, interface and/or processing resources. For example, each radio modem 610 or similar communication device 630 (e.g., an RFID scanner for scanning machine-readable information) may also include some sort of common interface 620 for communicating with master control system 640. As a result, all information, commands, etc. occurring between radio modems 610, similar devices 630 and MRC 600 are conveyed by the communication resources of master control system 640. The possible effect of sharing communication resources with all the other functional modules within WCD 100 will be discussed with respect to FIG. 6C.

FIG. 6C discloses an operational diagram similar to FIG. 4 including the effect of MRC 600 in accordance with at least one embodiment of the present invention. In this system MRC 600 may receive operational data from the master operating system of WCD 100, concerning for example applications running in application level 410, and status data from the various radio communication devices in service level 430. MRC 600 may use this information to issue scheduling commands to the communication devices in service level 430 in an attempt to avoid communication problems. However, problems may occur when the operations of WCD 100 are fully employed. Since the various applications in application level 410, the operating system in system level 420, the communication devices in service level 430 and MRC 600 must all share the same communication system, delays may occur when all aspects of WCD 100 are trying to communicate on the common interface system 620. As a result, delay sensitive information regarding both communication resource status information and radio modem 610 control information may become delayed, nullifying any beneficial effect from MRC 600. Therefore, a system better able to handle the differentiation and routing of delay sensitive information is required if the beneficial effect of MRC 600 is to be realized.

### VI. A Wireless Communication Device Including a Multiradio Control System.

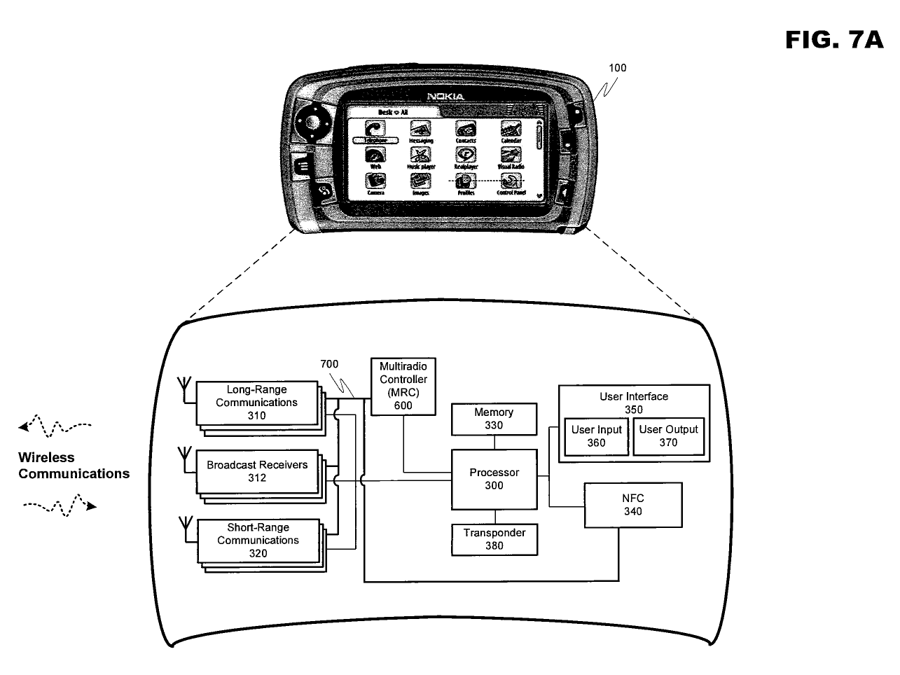

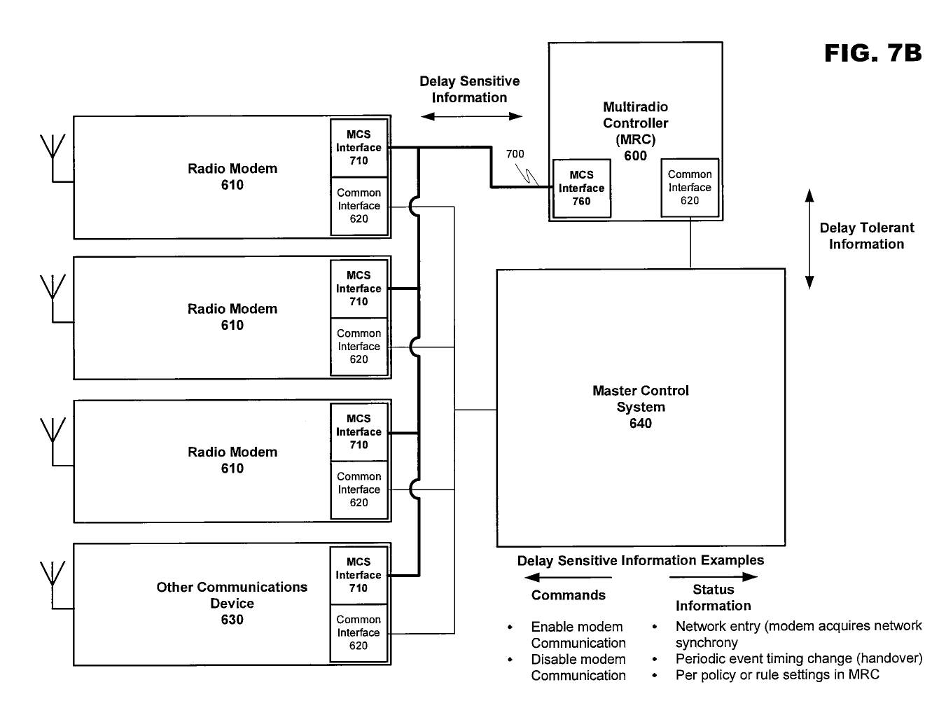

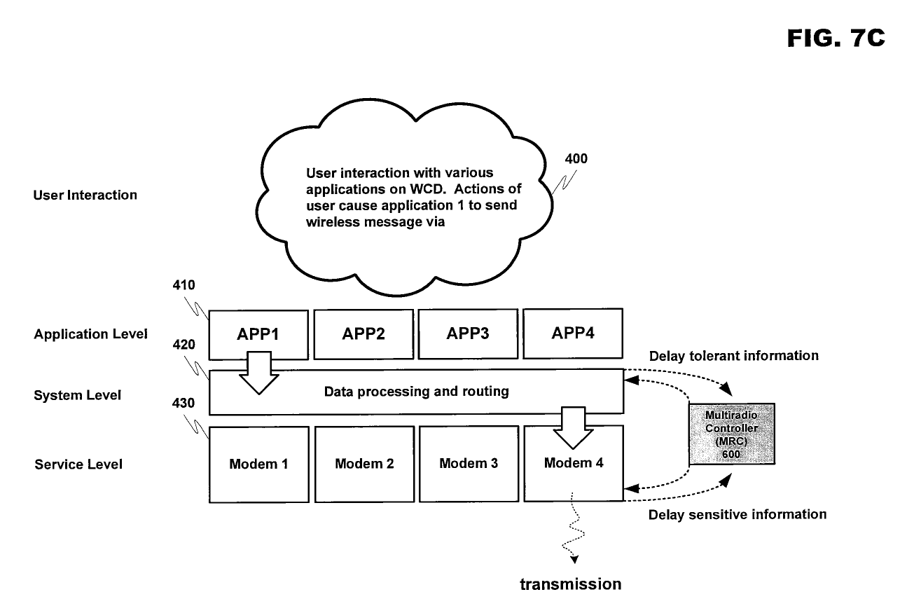

FIG. 7A introduces MRC 600 as part of a multiradio control system (MCS) 700 in WCD 100 in accordance with at least one embodiment of the present invention. MCS 700 directly links the communication resources of modules 310, 312, 320 and 340 to MRC 600. MCS 700 may provide a dedicated low-traffic communication structure for carrying delay sensitive information both to and from MRC 600.

Additional detail is shown in FIG. 7B. MCS 700 forms a direct link between MRC 600 and the communication resources of WCD 100. This link may be established by a system of dedicated MCS interfaces 710 and 760. For example, MCS interface 760 may be coupled to MRC 600. MCS Interfaces 710 may connect radio modems 610 and other similar communication devices 630 to MCS 700 in order to form an information conveyance for allowing delay sensitive information to travel to and from MRC 600. In this way, the abilities of MRC 600 are no longer influenced by the processing load of master control system 640. As a result, any information still communicated by master control system 640 to and from MRC 600 may be deemed delay tolerant, and therefore, the actual arrival time of this information does not substantially influence system performance. On the other hand, all delay sensitive information is directed to MCS 700, and therefore is insulated from the loading of the master control system.

The effect of MCS 700 is seen in FIG. 7C in accordance with at least one embodiment of the present invention. Information may now be received in MRC 600 from at least two sources. System level 420 may continue to provide information to MRC 600 through master control system 640. In addition, service level 430 may specifically provide delay sensitive information conveyed by MCS 700. MRC 600 may distinguish between these two classes of information and act accordingly. Delay tolerant information may include information that typically does not change when a radio modem is actively engaged in communication, such as radio mode information (e.g., GPRS, Bluetooth™, WLAN, etc.), priority information that may be defined by user settings, the specific service the radio is driving (QoS, real time/non real time), etc. Since delay tolerant information changes infrequently, it may be delivered in due course by master control system 640 of WCD 100. Alternatively, delay sensitive (or time sensitive) information includes at least modem operational information that frequently changes during the course of a wireless connection, and therefore, requires immediate update. As a result, delay sensitive information may need to be delivered directly from the plurality of radio modems 610 through the MCS interfaces 710 and 760 to MRC 600, and may include radio modem synchronization information. Delay sensitive information may be provided in response to a request by MRC 600, or may be delivered as a result of a change in radio modem settings during transmission, as will be discussed with respect to synchronization below.

### VIII. A Wireless Communication Device Including a Distributed Multiradio Control System.

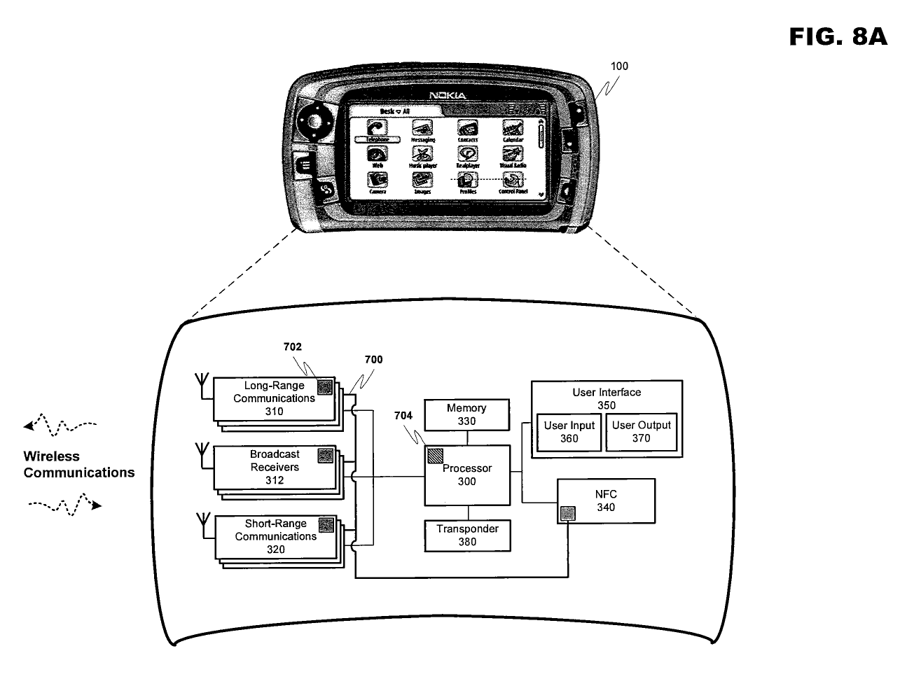

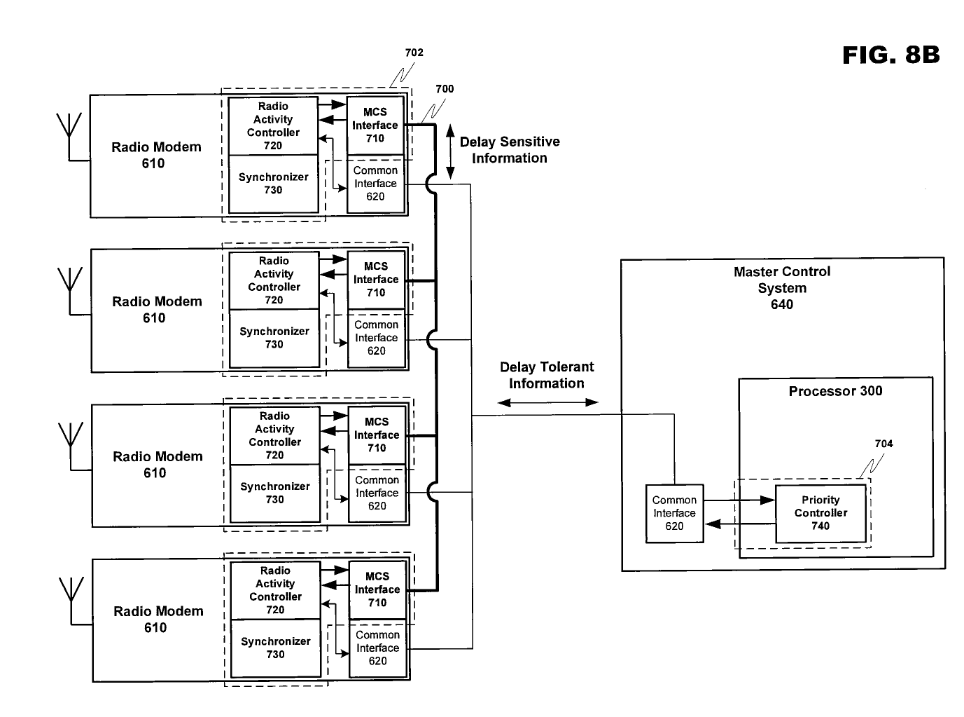

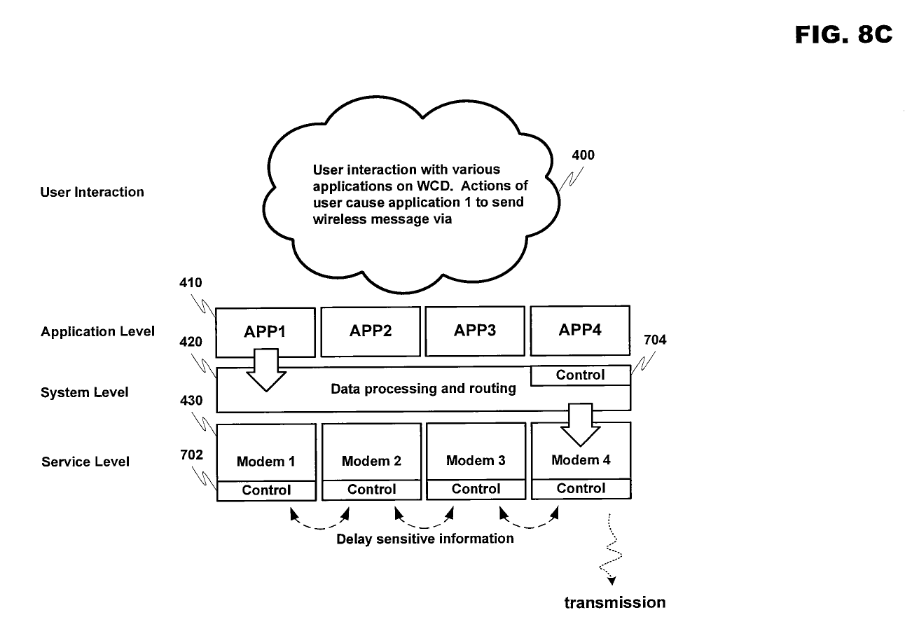

FIG. 8A discloses an alternative configuration in accordance with at least one embodiment of the present invention, wherein a distributed multiradio control system (MCS) 700 is introduced into WCD 100. Distributed MCS 700 may, in some cases, be deemed to provide an advantage over a centralized MRC 600 by distributing these control features into already necessary components within WCD 100. As a result, a substantial amount of the communication management operations may be localized to the various communication resources, such as radio modems (modules) 610, reducing the overall amount of control command traffic in WCD 100.

MCS 700, in this example, may be implemented utilizing a variety of bus structures, including the I²C interface commonly found in portable electronic devices, as well as emerging standards such as SLIMbus that are now under development. I²C is a multi-master bus, wherein multiple devices can be connected to the same bus and each one can act as a master through initiating a data transfer. An I²C bus contains at least two communication lines, an information line and a clock line. When a device has information to transmit, it assumes a master role and transmits both its clock signal and information to a recipient device. SLIMbus, on the other hand, utilizes a separate, non-differential physical layer that runs at rates of 50 Mbits/s or slower over just one lane. It is being developed by the Mobile Industry Processor Interface (MIPI) Alliance to replace today's I²C and I²S interfaces while offering more features and requiring the same or less power than the two combined.

MCS 700 directly links distributed control components 702 in modules 310, 312, 320 and 340. Another distributed control component 704 may reside in master control system 640 of WCD 100. It is important to note that distributed control component 704 shown in processor 300 is not limited only to this embodiment, and may reside in any appropriate system module within WCD 100. The addition of MCS 700 provides a dedicated low-traffic communication structure for carrying delay sensitive information both to and from the various distributed control components 702.

The exemplary embodiment disclosed in FIG. 8A is described with more detail in FIG. 8B. MCS 700 forms a direct link between distributed control components 702 within WCD 100. Distributed control components 702 in radio modems 610 (together forming a “module”) may, for example, consist of MCS interface 710, radio activity controller 720 and synchronizer 730. Radio activity controller 720 uses MCS interface 710 to communicate with distributed control components in other radio modems 610. Synchronizer 730 may be utilized to obtain timing information from radio modem 610 to satisfy synchronization requests from any of the distributed control components 702. Radio activity controller 702 may also obtain information from master control system 640 (e.g., from distributed control component 704) through common interface 620. As a result, any information communicated by master control system 640 to radio activity controller 720 through common interface 620 may be deemed delay tolerant, and therefore, the actual arrival time of this information does not substantially influence communication system performance. On the other hand, all delay sensitive information may be conveyed by MCS 700, and therefore is insulated from master control system overloading.

As previously stated, a distributed control component 704 may exist within master control system 640. Some aspects of this component may reside in processor 300 as, for example, a running software routine that monitors and coordinates the behavior of radio activity controllers 720. Processor 300 is shown to contain priority controller 740. Priority controller 740 may be utilized to monitor active radio modems 610 in order to determine priority amongst these devices. Priority may be determined by rules and/or conditions stored in priority controller 740. Modems that become active may request priority information from priority controller 740. Further, modems that go inactive may notify priority controller 740 so that the relative priority of the remaining active radio modems 610 may be adjusted accordingly. Priority information is usually not considered delay sensitive because it is mainly updated when radio modems 610 activate/deactivate, and therefore, does not frequently change during the course of an active communication connection in radio modems 610. As a result, this information may be conveyed to radio modems 610 using common interface system 620 in at least one embodiment of the present invention.

At least one effect of a distributed control MCS 700 is seen in FIG. 8C. System level 420 may continue to provide delay tolerant information to distributed control components 702 through master control system 640. In addition, distributed control components 702 in service level 430, such as modem activity controllers 720, may exchange delay sensitive information with each other via MCS 700. Each distributed control component 702 may distinguish between these two classes of information and act accordingly. Delay tolerant information may include information that typically does not change when a radio modem is actively engaged in communication, such as radio mode information (e.g., GPRS, Bluetooth™, WLAN, etc.), priority information that may be defined by user settings, the specific service the radio is driving (QoS, real time/non real time), etc. Since delay tolerant information changes infrequently, it may be delivered in due course by master control system 640 of WCD 100. Alternatively, delay sensitive (or time sensitive) information may include at least modem operational information that frequently changes during the course of a wireless connection, and therefore, requires immediate update. Delay sensitive information needs to be delivered directly between distributed control components 702, and may include radio modem synchronization and activity control information. Delay sensitive information may be provided in response to a request, or may be delivered as a result of a change in radio modem, which will be discussed with respect to synchronization below.

MCS interface 710 may be used to (1) Exchange synchronization information, and (2) Transmit identification or prioritization information between various radio activity controllers 720. In addition, as previously stated, MCS interface 710 is used to communicate the radio parameters that are delay sensitive from a controlling point of view. MCS interface 710 can be shared between different radio modems (multipoint) but it cannot be shared with any other functionality that could limit the usage of MCS interface 710 from a latency point of view.

The control signals sent on MCS 700 that may enable/disable a radio modem 610 should be built on a modem's periodic events. Each radio activity controller 720 may obtain this information about a radio modem's periodic events from synchronizer 730. This kind of event can be, for example, frame clock event in GSM (4.615 ms), slot clock event in Bluetooth™ (625 us) or targeted beacon transmission time in WLAN (100 ms) or any multiple of these. A radio modem 610 may send its synchronization indications when (1) Any radio activity controller 720 requests it, (2) a radio modem internal time reference is changed (e.g. due to handover or handoff). The latency requirement for the synchronization signal is not critical as long as the delay is constant within a few microseconds. The fixed delays can be taken into account in the scheduling logic of radio activity controller 710.

For predictive wireless communication mediums, the radio modem activity control may be based on the knowledge of when the active radio modems 610 are about to transmit (or receive) in the specific connection mode in which the radios are currently operating. The connection mode of each radio modem 610 may be mapped to the time domain operation in their respective radio activity controller 720. As an example, for a GSM speech connection, priority controller 740 may have knowledge about all traffic patterns of GSM. This information may be transferred to the appropriate radio activity controller 720 when radio modem 610 becomes active, which may then recognize that the speech connection in GSM includes one transmission slot of length 577 its, followed by an empty slot after which is the reception slot of 577 μs, two empty slots, monitoring (RX on), two empty slots, and then it repeats. Dual transfer mode means two transmission slots, empty slot, reception slot, empty slot, monitoring and two empty slots. When all traffic patterns that are known a priori by the radio activity controller 720, it only needs to know when the transmission slot occurs in time to gain knowledge of when the GSM radio modem is active. This information may be obtained by synchronizer 730. When the active radio modem 610 is about to transmit (or receive) it must check every time whether the modem activity control signal from its respective radio activity controller 720 permits the communication. Radio activity controller 720 is always either allowing or disabling the transmission of one full radio transmission block (e.g. GSM slot).

### IX. A Wireless Communication Device Including an Alternative Example of a Distributed Multiradio Control System.

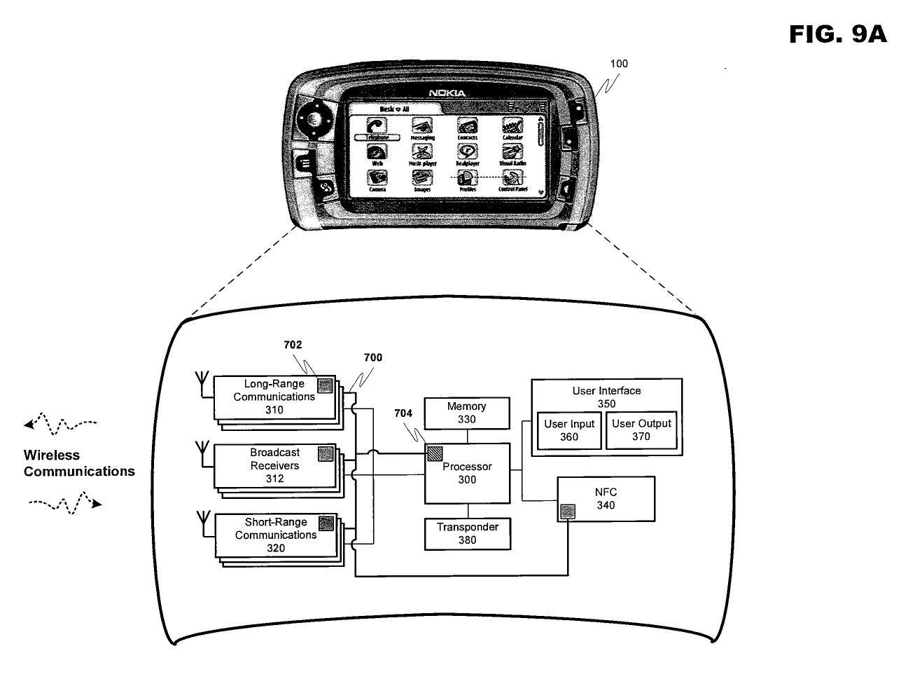

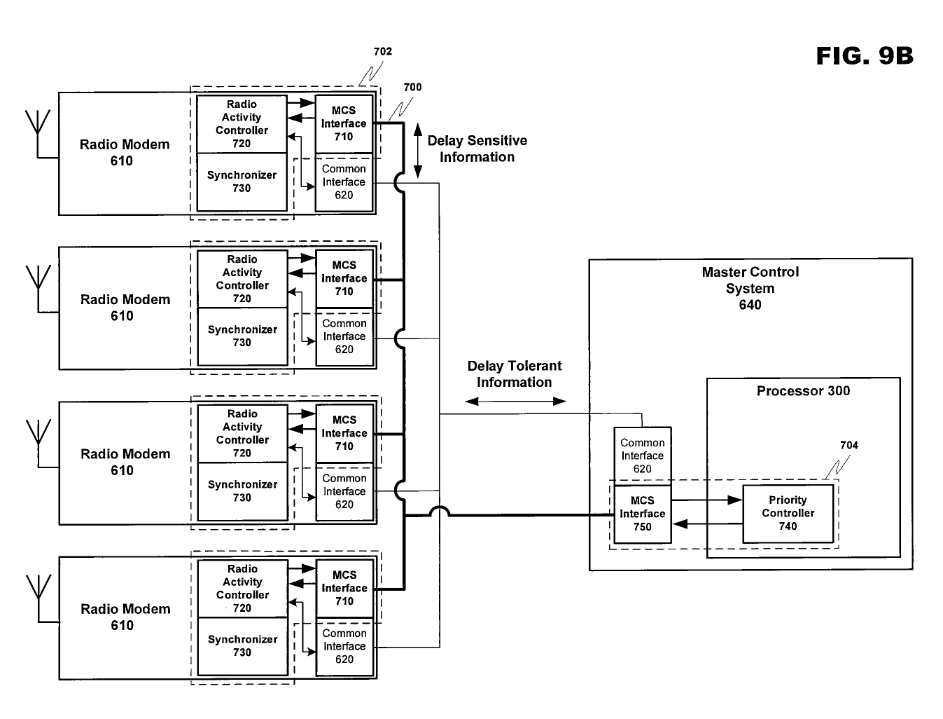

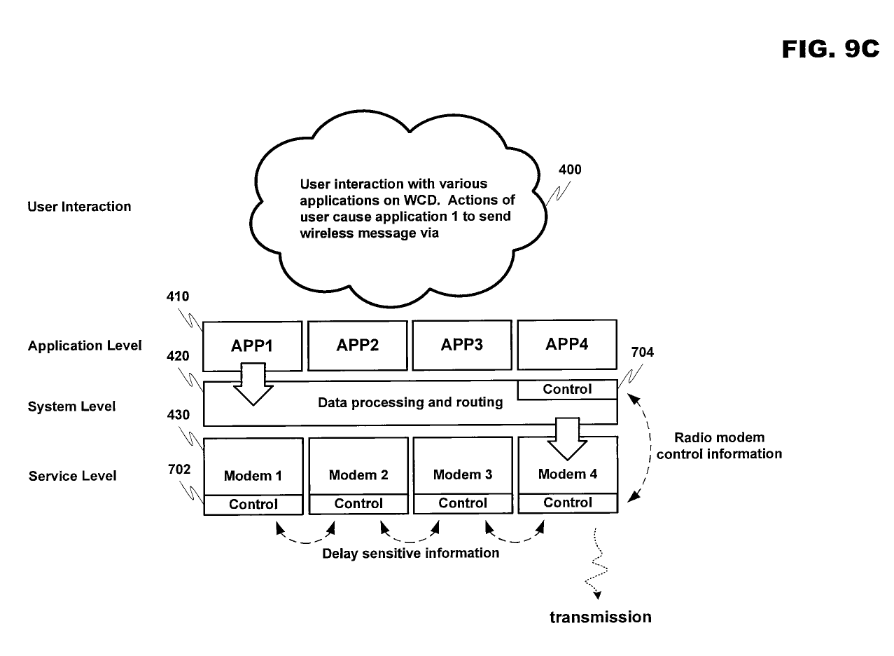

An alternative distributed control configuration in accordance with at least one embodiment of the present invention is disclosed in FIG. 9A-9C. In FIG. 9A, distributed control components 702 continue to be linked by MCS 700. However, now distributed control component 704 is also directly coupled to distributed control components 702 via an MCS interface. As a result, distributed control component 704 may also utilize and benefit from MCS 700 for transactions involving the various communication components of WCD 100.

Referring now to FIG. 9B, the inclusion of distributed control component 704 onto MCS 700 is shown in more detail. Distributed control component 704 includes at least priority controller 740 coupled to MCS interface 750. MCS interface 750 allows priority controller 740 to send information to, and receive information from, radio activity controllers 720 via a low-traffic connection dedicated to the coordination of communication resources in WCD 100. As previously stated, the information provided by priority controller 740 may not be deemed delay sensitive information, however, the provision of priority information to radio activity controllers 720 via MCS 700 may improve the overall communication efficiency of WCD 100. Performance may improve because quicker communication between distributed control components 702 and 704 may result in faster relative priority resolution in radio activity controllers 720. Further, the common interface system 620 of WCD 100 will be relieved of having to accommodate communication traffic from distributed control component 704, reducing the overall communication load in master control system 640. Another benefit may be realized in communication control flexibility in WCD 100. New features may be introduced into priority controller 740 without worrying about whether the messaging between control components will be delay tolerant or sensitive because an MCS interface 710 is already available at this location.

FIG. 9C discloses the operational effect of the enhancements seen in the current alternative embodiment of the present invention on communication in WCD 100. The addition of an alternative route for radio modem control information to flow between distributed control components 702 and 704 may both improve the communication management of radio activity controllers 720 and lessen the burden on master control system 640. In this embodiment, all distributed control components of MCS 700 are linked by a dedicated control interface, which provides immunity to communication coordination control messaging in WCD 100 when the master control system 640 is experiencing elevated transactional demands.

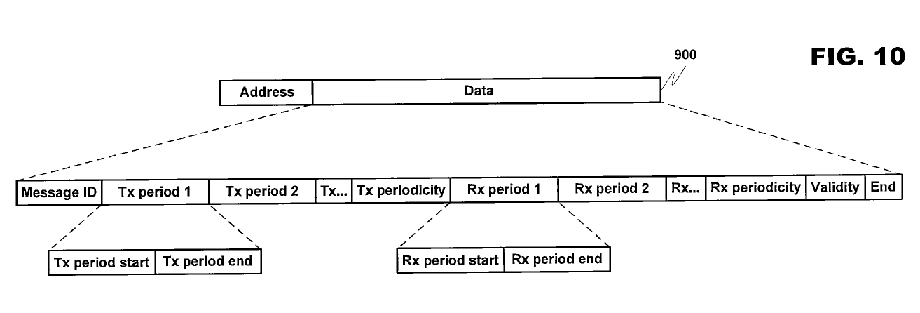

An example message packet 900 is disclosed in FIG. 10 in accordance with at least one embodiment of the present invention. Example message packet 900 includes activity pattern information that may be formulated by MRC 600 or radio activity controller 720. The data payload of packet 900 may include, in at least one embodiment of the present invention, at least Message ID information, allowed/disallowed transmission (Tx) period information, allowed/disallowed reception (Rx) period information, Tx/Rx periodicity (how often the Tx/Rx activities contained in the period information occur), and validity information describing when the activity pattern becomes valid and whether the new activity pattern is replacing or added to the existing one. The data payload of packet 900, as shown, may consist of multiple allowed/disallowed periods for transmission or reception (e.g., Tx period 1, 2 . . . ) each containing at least a period start time and a period end time during which radio modem 610 may either be permitted or prevented from executing a communication activity. While the distributed example of MCS 700 may allow radio modem control activity to be controlled real-time (e.g., more control messages with finer granularity), the ability to include multiple allowed/disallowed periods into a single message packet 900 may support radio activity controllers 720 in scheduling radio modem behavior for longer periods of time, which may result in a reduction in message traffic. Further, changes in radio modem 610 activity patterns may be amended using the validity information in each message packet 900.

The modem activity control signal (e.g., packet 900) may be formulated by MRC 600 or radio activity controller 720 and transmitted on MCS 700. The signal includes activity periods for Tx and Rx separately, and the periodicity of the activity for the radio modem 610. While the native radio modem clock is the controlling time domain (never overwritten), the time reference utilized in synchronizing the activity periods to current radio modem operation may be based on one of at least two standards. In a first example, a transmission period may start after a pre-defined amount of synchronization events have occurred in radio modem 610. Alternatively, all timing for MRC 600 or between distributed control components 702 may be standardized around the system clock for WCD 100. Advantages and disadvantages exist for both solutions. Using a defined number of modem synchronization events is beneficial because then all timing is closely aligned with the radio modem clock. However, this strategy may be more complicated to implement than basing timing on the system clock. On the other hand, while timing based on the system clock may be easier to implement as a standard, conversion to modem clock timing must necessarily be implemented whenever a new activity pattern is installed in radio modem 610.

The activity period may be indicated as start and stop times. If there is only one active connection, or if there is no need to schedule the active connections, the modem activity control signal may be set always on allowing the radio modems to operate without restriction. The radio modem 610 should check whether the transmission or reception is allowed before attempting actual communication. The activity end time can be used to check the synchronization. Once the radio modem 610 has ended the transaction (slot/packet/burst), it can check whether the activity signal is still set (it should be due to margins). If this is not the case, the radio modem 610 can initiate a new synchronization with MRC 600 or with radio activity controller 720 through synchronizer 730. The same happens if a radio modem time reference or connection mode changes. A problem may occur if radio activity controller 720 runs out of the modem synchronization and starts to apply modem transmission/reception restrictions at the wrong time. Due to this, modem synchronization signals need to be updated periodically. The more active wireless connections, the more accuracy is required in synchronization information.

### X. Radio Modem Interface to Other Devices.

As a part of information acquisition services, the MCS interface 710 needs to send information to MRC 600 (or radio activity controllers 720) about periodic events of the radio modems 610. Using its MCS interface 710, the radio modem 610 may indicate a time instance of a periodic event related to its operation. In practice these instances are times when radio modem 610 is active and may be preparing to communicate or communicating. Events occurring prior to or during a transmission or reception mode may be used as a time reference (e.g., in case of GSM, the frame edge may be indicated in a modem that is not necessarily transmitting or receiving at that moment, but we know based on the frame clock that the modem is going to transmit [x]ms after the frame clock edge). Basic principle for such timing indications is that the event is periodic in nature. Every incident needs not to be indicated, but the MRC 600 may calculate intermediate incidents itself. In order for that to be possible, the controller would also require other relevant information about the event, e.g. periodicity and duration. This information may be either embedded in the indication or the controller may get it by other means. Most importantly, these timing indications need to be such that the controller can acquire a radio modem's basic periodicity and timing. The timing of an event may either be in the indication itself, or it may be implicitly defined from the indication information by MRC 600 (or radio activity controller 720).

In general terms these timing indications need to be provided on periodic events like: schedule broadcasts from a base station (typically TDMA/MAC frame boundaries) and own periodic transmission or reception periods (typically Tx/Rx slots). Those notifications need to be issued by the radio modem 610: (1) on network entry (i.e. modem acquires network synchrony), (2) on periodic event timing change e.g. due to a handoff or handover and (3) as per the policy and configuration settings in the multiradio controller (monolithic or distributed).

In at least one embodiment of the present invention, the various messages exchanged between the aforementioned communication components in WCD 100 may be used to dictate behavior on both a local (radio modem level) and global (WCD level) basis. MRC 600 or radio activity controller 720 may deliver a schedule to radio modem 610 with the intent of controlling that specific modem, however, radio modem 610 may not be compelled to conform to this schedule. The basic principle is that radio modem 610 is not only operating according to multiradio control information (e.g., operates only when MRC 600 allows) but is also performing internal scheduling and link adaptation while taking MRC scheduling information into account.

### XI. Resolution of Communication Control to the Wireless Message Stream Level.

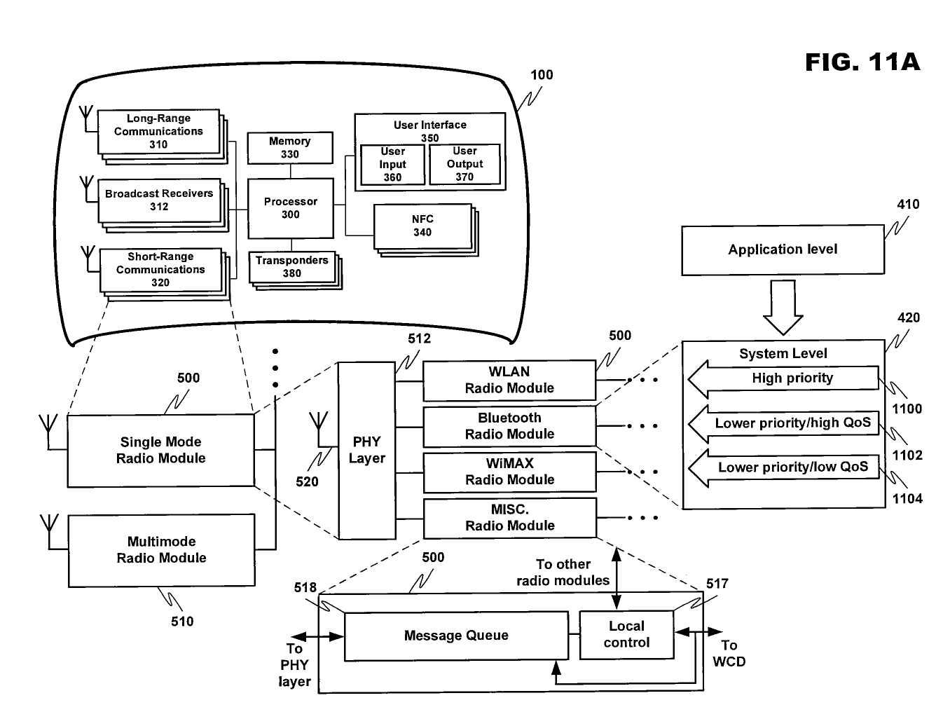

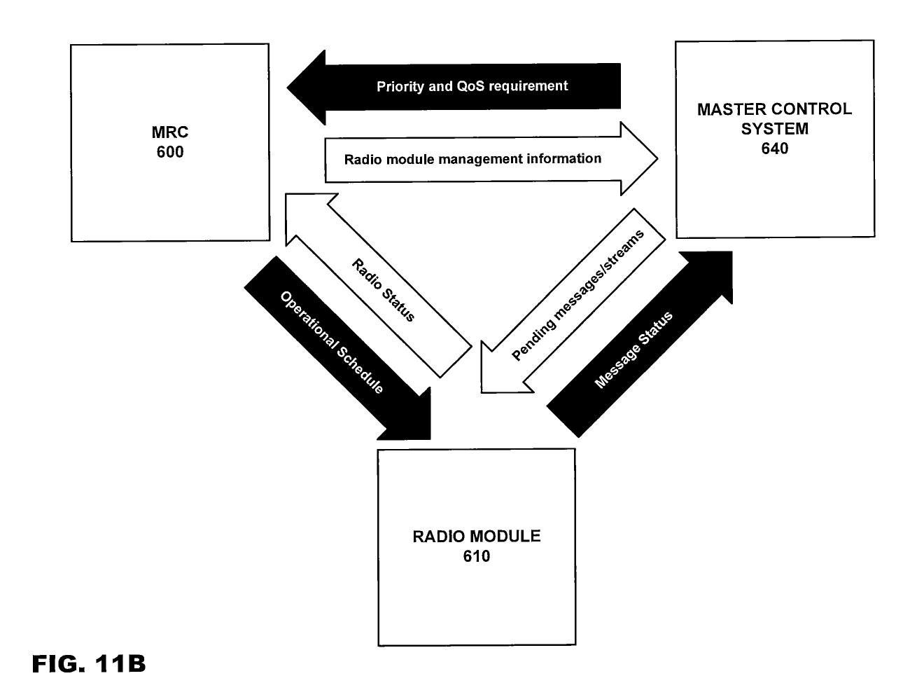

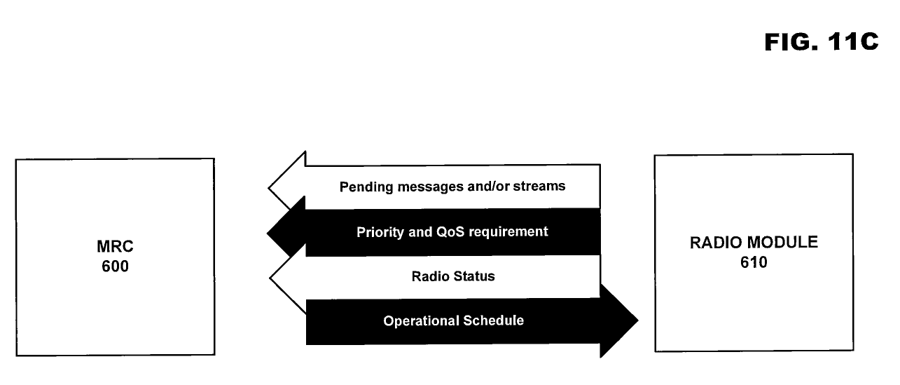

FIG. 11A expands further on the exemplary single mode radio module 500 disclosed in FIG. 5A. Now in FIG. 11A, a single mode radio module 500 is disclosed that is configured to support multiple wireless message streams. In this example, a Bluetooth™ single mode radio module 500 is supporting at least three wireless message streams 1100-1104. These streams may be supplied through software resources in system level 420 which have been triggered or activated by programs residing in application level 410. For example, user 110 may desire to make a telephone call, but instead of using a typical cellular communication medium like GSM, user 110 may instead elect to use voice over Internet protocol (VoIP). The VoIP option may be preferable, for example, due to no cellular signal being available in the current location of user 110 (e.g., inside a building). The VoIP connection may be established, for example, through a Bluetooth™ or WLAN network link to a wireless access point within communication range of WCD 100. The VoIP connection may be deemed relatively important with respect to other activities also occurring in WCD 100, and therefore, considered high priority. In making the call, user 110 may activate a VoIP telephone interface program resident in application level 410, which may in turn route VoIP packets through resources residing in system level 420. These steps may result in high priority wireless message stream 1100 conveyed by at least one of Bluetooth™ or WLAN radio modules 500 as shown in FIG. 11A.

Continuing with the previous example, user 110 may also desire to utilize a Bluetooth™ wireless headset coupled to WCD 100 over which the VoIP call may be conducted. Again, user 110 may initiate a program in application level 410 (for example, by interacting with user interface 350) in order to wireless couple the headset to WCD 100 via Bluetooth™. The application level program may in turn access resources in system level 420, which may then manifest in lower priority/high QoS wireless message stream 1102. In other words, wireless message stream 1102 may be lower priority than wireless message stream 1100, but may still require a high QoS to ensure that user 110 can communicate during the VoIP telephone call.

Also active concurrently with the previous two wireless message streams 1100 and 1102, another Bluetooth™ wireless link may exist to couple WCD 100 to a wireless keyboard. In the same manner as described above, user interaction with application level 410 may call upon resources in system level 420 to create a third wireless message stream 1104 representing the link to the wireless keyboard. The amount of data transferred from the keyboard may be substantially less than the previously described links, and therefore, the QoS required may also be substantially lower. Lower priority/low QoS wireless message stream 1104 may then represent the wireless link from the Bluetooth™-enabled keyboard to WCD 100. As set forth above, all of these wireless links may be active at the same time, so a control strategy that only resolves control down to the wireless communication medium or radio module level may not be able to manage these wireless links in order to avoid potential communication conflicts. More specifically, in the best case scenario for the effectiveness of communication management implemented by MRC 600, wireless message streams will operate using different wireless communication mediums supported by different radio modules 500, which may allow MRC 600 to readily formulate an operational schedule at the wireless communication medium or radio module level in accordance with previously disclosed management strategies. In the worst case scenario, all three wireless streams would utilize the same wireless communication medium and radio module 500 relatively simultaneously, greatly reducing any benefit experienced from current scheduling solutions not able to organize communication down to this level of precision.

Now referring to FIG. 11B, an exemplary interaction of components in WCD 100, in accordance with at least one embodiment of the present invention, is now disclosed. It is important to note that the types of information that are discussed as being exchanged in FIG. 11B and 11C have been utilized for the sake of explanation in the present disclosure, and further that the present invention is not limited to only exchanging the information specifically disclosed in these figures. The present invention may exchange any information relevant to the management of wireless resources for supporting wireless communication mediums utilized in WCD 100.

In the configuration shown in FIG. 11B, MRC 600 may exchange information with one or more radio modules 610 over common interface 620 and/or MCS interface 710. Also, MRC 600 may exchange information with master control system 640 using the aforementioned interfaces. Master control system 640 may represent any other software and/or hardware resource in WCD 100, and may include, for example, programs operating in application level 410 and system level 420 as previously described. In the interaction with one or more radio modules 610, MRC may receive status information pertaining to the current activities of the radio modules 610, and may in turn utilize this information in the creation of operational schedules which are then distributed to the one or more radio modules 610. In return, WCD 600 may inform master control system 640 of the scheduled communication that is planned to take place via the one or more radio modules 610. This information may be utilized by master control system 640 to adjust the priorities of the active wireless message streams.

MRC 600 may also receive information from master control system 640 which is utilized in the formulation of operational schedules. This information may include, for example, priority information and QoS requirements for the various active wireless message streams. The priority information may be determined, for example, in view of message status information sent from the one or more radio modules 610 to master control system 640. In at least one scenario, the one or more radio modules 610 may report that certain messages have been queued for a long duration, that a particular wireless communication medium or wireless message stream has a large number of messages, pending, etc. This type of message information may then be utilized to compute (or update) the priority information that may be provided to MRC 600.

In interacting with master control system 640, the one or more radio modules 610 may receive information pertaining to wireless message packets/wireless message streams awaiting access to the one or more radio modules 610. Further, this information may be provided by application layer 410 through system layer 420 as previously described in order to notify the one or more radio modules 610 that resources are desired to support a wireless message stream. This information may include wireless communication medium type, duration information, etc., that may be provided to MRC 600 as part of the radio status information.

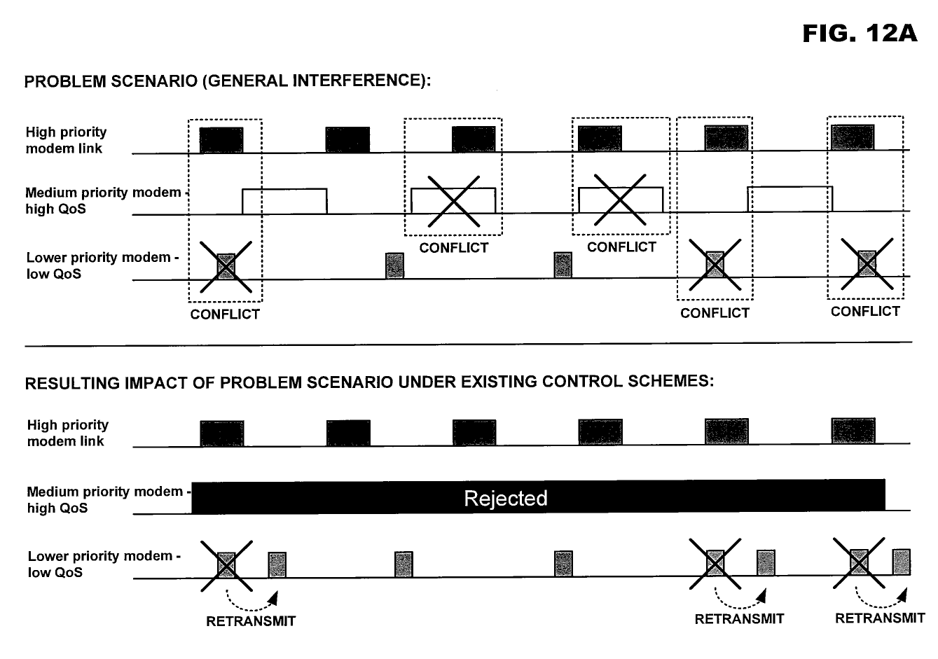

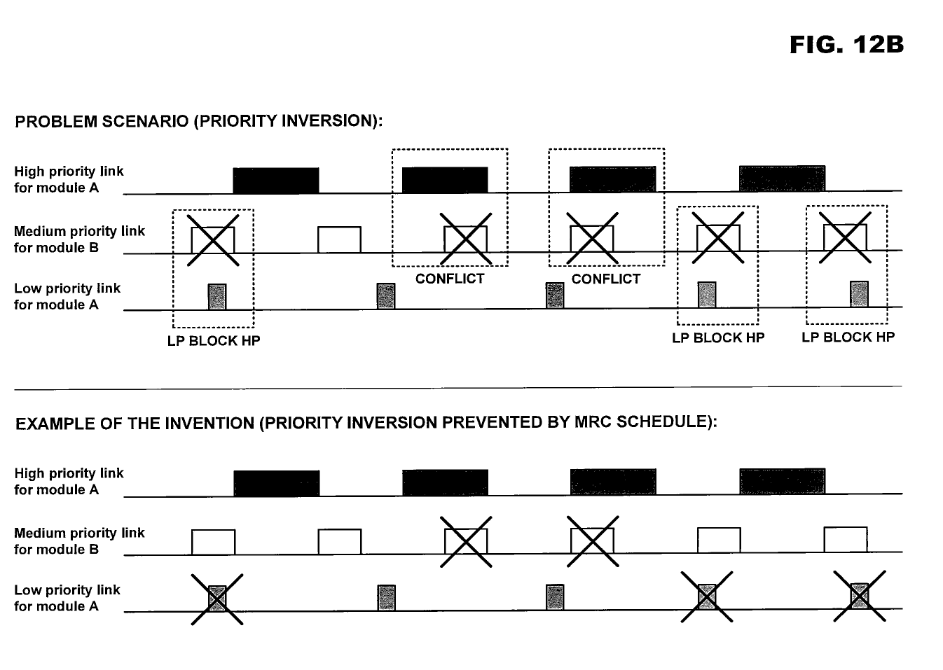

FIG. 11C discloses another exemplary configuration of the present invention wherein MRC 600 may only need to exchange information relevant to formulating an operational schedule with the one or more radio modules 610. As shown in FIG. 11C, MRC 600 may receive information pertaining to messages and/or wireless message streams awaiting access to the one or more radio modules 610, the priority and QoS requirement for each wireless message stream, the radio module status information for each of the one or more radio modules, etc. This information may then be utilized by WCD 100 when formulating operational schedules for distribution to the one or more radio modules 610. As set forth above, and in accordance with at least one embodiment of the present invention, operational schedules formulated by MRC 600 may be utilized by the one or more radio modules 610 in order to control the allocation of radio module resources. FIGS. 12A and 12B now provide exemplary situations wherein operational schedules may be utilized in order to avoid potential communication conflicts.

Now referring to FIG. 12A, an exemplary problem scenario and a possible impact the exemplary problem scenario may have on overall wireless communication in WCD 100 is now disclosed. At least one radio module 610 including multiple wireless message streams (“modem links” in this example) is shown. A high priority modem link, a medium priority link with a high QoS requirement and lower priority link with a low QoS requirement all desire to access the at least one radio module 610 substantially at the same time. Initially, the operation of the high priority modem link will be preserved in view of any potential conflict, and therefore, packets in the medium and low priority wireless communication streams will be sacrificed if necessary. Any packets that may be scheduled for cancellation in order to avoid potential conflicts in this example are shown with an “X” superimposed such as on the top of FIG. 12A.

In the process of formulating an operational schedule for this scenario, MRC 600 may evaluate whether it is possible that a particular wireless message stream may not be able to achieve the required QoS due to conditions existing in WCD 100. In FIG. 12A, the lower priority modem with a high QoS requirement experiences a loss of 50% of the packets in its wireless message stream over the period of time shown, with no opportunity to retransmit these messages (e.g., there is not enough unallocated time available to retransmit the canceled packets even if packet retransmission is supported). Without the ability to schedule activity at a higher resolution, for example, at the wireless message stream level as described in accordance with at least one embodiment of the present invention, it may not be possible for the lower priority-high QoS message stream to achieve the required QoS. MRC 600 may then be forced to optimize overall communication, regardless of priority, by rejecting the medium priority link. Rejection may include transmitting a notification to the one or more radio modules 610 or master control system 640 in order to deny radio module access to the problematic wireless message stream.

A possible negative effect of this management strategy is shown in the example on the bottom of FIG. 12A. Since the required QoS of the medium priority wireless message stream would never have been achieved (e.g., audio or video may have been broken, hesitant and/or pixilated) using an existing management strategy, the request for modem support was denied. All of the remaining packets may be successfully conveyed, though some of the lower priority modem-low QoS packets will have to be retransmitted. While this retransmission may be acceptable because of the low QoS requirement for this wireless message stream, the overall wireless communication performance of WCD 100 was negatively impacted because a medium priority wireless message stream was refused over a lower priority wireless message stream that was more compatible with a high priority communication, resulting in an inversion of priority.

FIG. 12B shows another exemplary problem scenario that may cause a similar “priority inversion” between multiple wireless message streams, and also, an example of how the present invention, in at least one embodiment, may help to manage this potential problem. In this example, a low priority link and high priority link are scheduled to operate concurrently in one radio module (radio module A). A medium priority link is scheduled to operate in another module (radio module B). As explained with regard to the previous example, as a general rule a high priority link will be preserved over other conflicting activity in WCD 100, and therefore, a schedule may plan to cancel potentially interfering packets from other wireless message streams. For example, some conflicting packets are scheduled to be canceled in the medium priority link. However, low priority packets from the first radio module may also interfere with the medium priority link, leaving only one packet in medium priority link remaining in the disclosed period.

Prior to the advent of the present invention, MRC 600 may view this problem scenario and decide to reject the entire medium priority link (since almost all of the packets have conflicts). As a result, the low priority link would be selected over the medium priority link since its schedule will not conflict with the high priority link (as managed, for example, by the radio module A). A “priority inversion” may then be deemed to occur, since the low priority wireless message stream was preserved over the medium priority wireless message stream by “riding” along with the high priority wireless message stream also supported by radio module A.

However, in at least one embodiment of the present invention, MRC 600 may be configured to formulate an operational schedule with resolution down the wireless message stream level, allowing the communication controller to employ a management strategy to account for the relative priority and QoS requirements of various wireless message streams. In the exemplary implementation of the present invention disclosed on the bottom of FIG. 12B, the operational schedule ensures that the relative priority of the wireless message streams will be preserved by canceling any low priority link packets that interfere with the medium priority link packets, thereby maintaining priority between wireless message streams and avoiding inversion.

More specifically, MRC 600 may, in view of delay-sensitive information sent from, for example, various radio modules 610 (e.g., transmission buffer sizes of various streams/applications etc.) and delay-tolerant information from master control system 640 (e.g., service/application type/ID/information/QoS/priority/needed frame rate/characteristics), as well as using its own knowledge regarding the characteristics of various radio modules 610, may reformulate operational schedules to allow for concurrent operation of the radio modules, which may provide control indication that instructs a particular module to transmit one or more packets within an allowed time window using a particular priority queue, such as transmitting the next packet from wireless message stream of certain priority/QoS/application, or even identify certain packets to be sent from each wireless message stream. In this exemplary arrangement, MRC 600 can schedule packets more specifically, and as a result, more efficiently manage concurrent communication in accordance with changing conditions in WCD 100. While this strategy may also result in more signaling between MRC 600 and radio modules 610, the increased traffic may be handled by the previously disclosed dual-bus architecture (e.g., common and MCS interfaces).

Operational schedule(s) formulated by MRC 600 may instruct radio modules 610 to release message packets using a variety of release strategies. For example, an operational schedule may identify a specific packet to be sent from the queue of a wireless message stream. On the other hand, MRC 600 may identify a QoS/priority level group/transmission buffer queue from which next packet(s) shall be sent. With this approach, the radio modules 610 can operate more responsively to changing conditions as MRC 600 assumes more control over the scheduling of communication within an allowed time window.

Further, when considering the various embodiments of the present invention, MRC 600 may provide operational schedule information to radio modules 610 using at least three different packet scheduling variations: 1) MRC 600 may indicate to radio modules 610 that it should transmit packets during next allowed time window from a particular transmission queue (e.g., having certain QoS/priority); 2) MRC 600 may indicate to a radio modules 610 to schedule packets between different transmission queues. For example, where “A” is a packet in queue A and “B” is a packet in queue B, MRC 600 may, where such resolution is supported, instruct that packets be transmitted in the order “A, B, B, A, A, B, A+,” wherein the “+” may indicate that the rest of the packets within the allowed time window be sent from queue A; and 3) MRC 600 may allow control entities in radio modules 610 to negotiate resource usage locally, but can override radio modems 610 during a local control time window to dictate a particular wireless message stream that should operate. This may be useful in situations when MRC 600 identifies a changing condition that requires fast reaction and response between MRC 600 and radio modems 610.

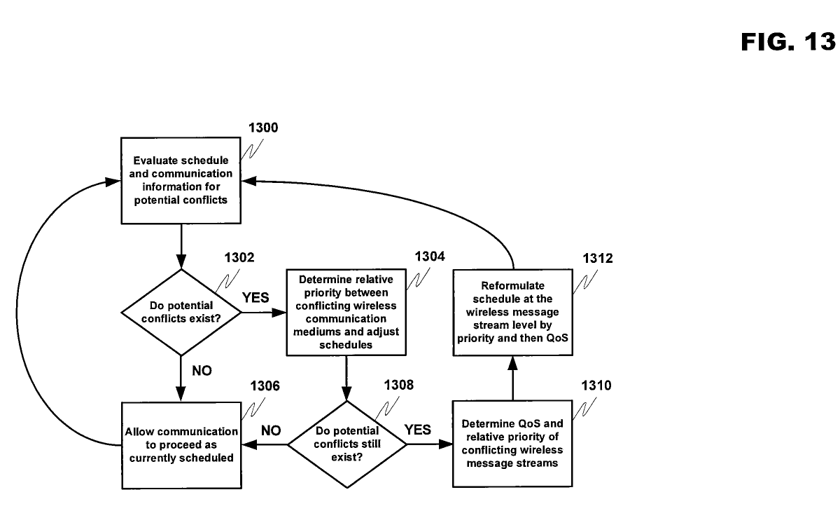

An exemplary process flow in accordance with at least one embodiment of the present invention is disclosed in FIG. 13. The exemplary process may initiate in step 1300, wherein MRC 600 may evaluate existing operational schedules pertaining to, for example, each wireless communication medium experiencing communication activity (e.g., from a wireless message stream), in order to determine if any potential communication conflicts exist. If no conflicts are located in the existing operational schedules (step 1302), then in step 1306 the operational schedules may be allowed to proceed (e.g., the current operational schedules may be distributed to the one or more radio modules 610 supporting each wireless communication medium). However, if potential conflicts are found, then the process may proceed to step 1304.

In step 1304 an initial determination may be made as to the relative priority of the conflicting wireless communication mediums. As previously set forth, the relative priority may be determined in view of criteria obtained from the one or more radio modules 610 or other hardware and/or software components making up master control system 640. This information may be related to the number of messages pending for each wireless communication medium and/or radio module, message age, message duration, message sources (e.g., requesting programs), wireless communication medium characteristics (e.g., whether retransmission is supported), message type, etc. MRC 600 may then try to reformulate the operational schedules in view of the relative priority of the wireless communication mediums. If all previous existing conflicts have been resolved, then in step 1306 communication may be allowed to proceed as described above. If conflicts still exist, then MRC 600 may begin a process to reformulate the operational schedules to a more-detailed level. In this way, communication management may operate at a higher level, which may be less resource intensive from a control standpoint (e.g., reduced inter-component signaling) until a scenario exists where finer management is needed.

In step 1310, MRC 600 may enter an increased resolution mode or configuration for managing communication-related activities in WCD 100 down to the wireless message stream level. The relative priority of any wireless message streams requesting access to the one or more radio modules 610 may be determined in view of characteristic information such as an assigned wireless message stream priority and required QoS for each wireless message stream. The wireless message stream activity may then be reformulated into new operational schedules in step 1312. As set forth above, this scheduling may identify specific message packets for transmission in certain time periods, may identify certain types of wireless message streams for operation in a time period, etc. The reformulated operational schedules may then be distributed to the one or more radio modules 610, and then the entire process may start again at step 1300.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
receiving activity information for all wireless communication mediums being supported by one or more radio modules in a wireless communication device;
formulating operational schedules for the one or more wireless communication mediums;
determining if any potential communication conflicts exist in the operational schedules;
if any potential communication conflicts exist, receiving activity information for each wireless message stream being supported by the wireless communication mediums, the information including at least priority information and required quality of service information for each wireless message stream, the wireless message stream activity information being utilized to reformulate the operational schedules; and
distributing the operational schedules to the one or more radio modules.

2. The method of claim 1, wherein a multiradio controller in the wireless communication device formulates and reformulates the operational schedules.

3. The method of claim 2, wherein the multiradio controller prioritizes all of the wireless message streams based on at least one of the wireless communication medium utilized by each wireless message stream, the priority information for each wireless message stream and the required quality of service information for each wireless message stream.

4. The method of claim 1, wherein the priority and required quality of service information are provided by the master control system of the wireless communication device.

5. The method of claim 1, wherein the priority and required quality of service information are provided by the particular radio module supporting the wireless message stream.

6. The method of claim 1, wherein the reformulated operational schedules indicate particular wireless message packets that should be transmitted by the one or more radio modules in a time period.

7. The method of claim 1, wherein the reformulated operational schedules permit communication activity for particular wireless message streams during a time period based on at least one of a priority threshold level and a quality of service threshold level.

8. The method of claim 1, wherein the reformulated operational schedules indicate wireless message streams that are permitted to transmit wireless message packets via one or more radio modules in a time period.

9. The method of claim 1, wherein the operational schedules are distributed to the radio modules via a dedicated interface for conveying delay-sensitive information.

10. A computer program product comprising a computer usable medium having computer readable program code embodied in said medium, comprising:
a computer readable program code configured to receive activity information for all wireless communication mediums being supported by one or more radio modules in a wireless communication device;
a computer readable program code configured to formulate operational schedules for the one or more wireless communication mediums;
a computer readable program code configured to determine if any potential communication conflicts exist in the operational schedules;
a computer readable program code configured to, if any potential communication conflicts exist, receive activity information for each wireless message stream being supported by the wireless communication mediums, the information including at least priority information and required quality of service information for each wireless message stream, the wireless message stream activity information being utilized to reformulate the operational schedules; and
a computer readable program code configured to distribute the operational schedules to the one or more radio modules.

11. The computer program product of claim 10, The method of claim 1, wherein a multiradio controller in the wireless communication device formulates and reformulates the operational schedules.

12. The computer program product of claim 11, wherein the multiradio controller prioritizes all of the wireless message streams based on at least one of the wireless communication medium utilized by each wireless message stream, the priority information for each wireless message stream and the required quality of service information for each wireless message stream.

13. The computer program product of claim 10, wherein the priority and required quality of service information are provided by the master control system of the wireless communication device.

14. The computer program product of claim 10, wherein the priority and required quality of service information are provided by the particular radio module supporting the wireless message stream.

15. The computer program product of claim 10, wherein the reformulated operational schedules indicate particular wireless message packets that should be transmitted by the one or more radio modules in a time period.

16. The computer program product of claim 10, wherein the reformulated operational schedules permit communication activity for particular wireless message streams during a time period based on at least one of a priority threshold level and a quality of service threshold level.

17. The computer program product of claim 10, wherein the reformulated operational schedules indicate wireless message streams that are permitted to transmit wireless message packets via one or more radio modules in a time period.

18. The computer program product of claim 10, wherein the operational schedules are distributed to the radio modules via a dedicated interface for conveying delay-sensitive information.

19. A wireless communication device, comprising:
at least one processor;
one or more radio modules configured to support a plurality of wireless communication mediums, the one or more radio modules being coupled to the at least one processor;
wherein the device is configured to:
receive activity information for all wireless communication mediums;
formulate operational schedules for the one or more wireless communication mediums;
determine if any potential communication conflicts exist in the operational schedules;
if any potential communication conflicts exist, receive activity information for each wireless message stream being supported by the wireless communication mediums, the information including at least priority information and required quality of service information for each wireless message stream, the wireless message stream activity information being utilized to reformulate the operational schedules; and
distribute the operational schedules to the one or more radio modules.

20. The device of claim 19, wherein the multiradio control module, the at least one processor and the one or more radio modules are coupled by a communication bus dedicated to conveying delay-sensitive communication.

21. A wireless communication device, comprising:
means for receiving notification of all wireless message streams that require access to one or more radio modules in the wireless communication device, the one or more radio modules being configured to support one or more wireless communication mediums;
means for receiving activity information for all wireless communication mediums being supported by one or more radio modules in a wireless communication device;
means for formulating operational schedules for the one or more wireless communication mediums;
means for determining if any potential communication conflicts exist in the operational schedules;
means for, if any potential communication conflicts exist, receiving activity information for each wireless message stream being supported by the wireless communication mediums, the information including at least priority information and required quality of service information for each wireless message stream, the wireless message stream activity information being utilized to reformulate the operational schedules; and
means for distributing the operational schedules to the one or more radio modules.

22. The device of claim 21, wherein the one or more radio modules are coupled to a multiradio control module via a communication bus dedicated to conveying delay-sensitive communication.

23. A multiradio controller, comprising:
at least one processing module;
at least one common interface module coupled to the at least one processor module; and
at least one interface dedicated to conveying delay-sensitive communication coupled to the at least one processor module;
wherein the controller is configured to:
receive activity information for all wireless communication mediums being supported by one or more radio modules in a wireless communication device;
formulate operational schedules for the one or more wireless communication mediums;
determine if any potential communication conflicts exist in the operational schedules;
if any potential communication conflicts exist, receive activity information for each wireless message stream being supported by the wireless communication mediums, the information including at least priority information and required quality of service information for each wireless message stream, the wireless message stream activity information being utilized to reformulate the operational schedules; and
distribute the operational schedules to the one or more radio modules.

24. A radio module, comprising:
one or more radio modems configured to support one or more wireless communication mediums; and
at least one interface module coupled to the one or more radio modems;
wherein the radio module is configured to:
receive, via the at least one interface module, operational schedule information related to the one or more wireless communication mediums for controlling the operation of the one or more wireless communication mediums; and
if the operational schedule information includes timeslot allocations for wireless message streams, control allocation of resources to one or more wireless message streams supported by the one or more wireless communication mediums.

25. A chipset, comprising:
at least one processing module;
one or more radio modules configured to support a plurality of wireless communication mediums, the one or more radio modules being coupled to the at least one processing module;
wherein the chipset is configured to:
receive activity information for all wireless communication mediums being supported by one or more radio modules in a wireless communication device;
formulate operational schedules for the one or more wireless communication mediums;
determine if any potential communication conflicts exist in the operational schedules;
if any potential communication conflicts exist, receive activity information for each wireless message stream being supported by the wireless communication mediums, the information including at least priority information and required quality of service information for each wireless message stream, the wireless message stream activity information being utilized to reformulate the operational schedules; and
distribute the operational schedules to the one or more radio modules.

26. A system, comprising:
a wireless communication device, the wireless communication device further comprising one or more radio modules for supporting a plurality of wireless communication mediums; and
a multiradio controller coupled to the one or more radio modules;
the multiradio controller receiving activity information for all wireless communication mediums being supported by one or more radio modules in a wireless communication device and formulating operational schedules for the one or more wireless communication mediums;
the multiradio controller further determining if any potential communication conflicts exist in the operational schedules, and if any potential communication conflicts exist, receiving activity information for each wireless message stream being supported by the wireless communication mediums, the information including at least priority information and required quality of service information for each wireless message stream, the wireless message stream activity information being utilized to reformulate the operational schedules; and
the multiradio controller distributing the operational schedules to the one or more radio modules.
